(19) United States
(12) Patent Application Publication
(10) Pub. No.: US 2025/0265976 A1
(43) Pub. Date: Aug. 21, 2025

(54) GATE DRIVING CIRCUIT AND DISPLAY DEVICE HAVING THE SAME

(71) Applicant: LG Display Co., Ltd., Seoul (KR)

(72) Inventors: YoungKyu SHIN, Chilgok-gun (KR); SeongHo CHO, Gumi-si (KR); Yeonji RYU, Andong-si (KR)

(73) Assignee: LG Display Co., Ltd., Seoul (KR)

(21) Appl. No.: 19/056,529

(22) Filed: Feb. 18, 2025

(30) Foreign Application Priority Data
Feb. 19, 2024 (KR) 10-2024-0023186

(51) Int. Cl. G09G 3/32

(52) U.S. Cl. CPC G09G 3/32; G09G 2300/0842; G09G 2310/0267; G09G 2310/0286; G09G 2380/10

(57) ABSTRACT

A gate driving circuit and a display device having the same are discussed. The gate driving circuit can include first to p-th stages, where an n-th stage among the first to p-th stages includes a selection scan signal generating unit configured to output a selection scan signal, based on an input signal and a second clock signal, and an output unit configured to output a first scan signal and a second scan signal based on the first selection scan signal, a first clock signal, and a control signal. The output unit can include a first controller configured to supply the selection scan signal to any one of a first output node and a second output node, based on the selection scan signal and the control signal, and a second controller configured to control the voltage of the first output node and the second output node.

### CROSS-REFERENCE TO RELATED APPLICATIONS

This application claims priority to Korean Patent Application No. 10-2024-0023186 filed on Feb. 19, 2024, in the Korean Intellectual Property Office, the entire disclosure of which are hereby expressly incorporated by reference into the present application.

### BACKGROUND

### Technical Field

The present disclosure relates to a gate driving circuit and a display device having the same, and more particularly, to a gate driving circuit which is capable of controlling a viewing angle for each active area and a display device having the same.

### Discussion of the Related Art

As the technology in modern society develops, display devices are used in various ways to provide information to users. The display devices are included in not only electronic signs which simply transmit visual information in one direction, but also various electronic devices which need a higher level of technology to check a user's input and provide information in response to the checked input.

For example, a display device is included in a vehicle to provide various information to a driver and the passengers of the vehicle. However, the display device of the vehicle needs to appropriately display contents without interrupting the operation of the vehicle. For example, the display device needs to limit the display of the contents which can reduce the concentration on the driving while the vehicle is in operation.

The description provided in the discussion of the related art section should not be assumed to be prior art merely because it is mentioned in or associated with that section. The discussion of the related art section can include information that describes one or more aspects of the subject technology, and the description in this section does not limit the invention.

### SUMMARY OF THE DISCLOSURE

A benefit to be achieved by the present disclosure is to provide a display device which divides a display panel into areas and independently controls a driving mode of each area.

Benefits of the present disclosure are not limited to the above-mentioned benefits, and other benefits, which are not mentioned above, can be clearly understood by those skilled in the art from the following descriptions.

According to an aspect of the present disclosure, a gate driving circuit includes first to p-th (p is an integer larger than 1) stages, and an n-th (n is an integer which is equal to or larger than 1 and equal to or smaller than p) stage among the first to p-th stages can include: a selection scan signal generating unit configured to output a selection scan signal, based on an input signal which is any one of a start signal or a previous carry signal and a second clock signal; and an output unit configured to output a first scan signal and a second scan signal based on the selection scan signal, a first clock signal, and a control signal. The output unit can include a first controller configured to supply the selection scan signal to any one of a first output node and a second output node, based on the selection scan signal and the control signal; and a second controller configured to control a voltage of the first output node and a voltage of the second output node, outputs a voltage of the first output node as the first scan signal, and outputs a voltage of the second output node as the second scan signal, based on the first clock signal, a first voltage, and a second voltage which is lower than the first voltage.

According to another aspect of the present disclosure, a display device can include a first pixel which is connected to a first scan line, a data line, a first power line to which a first power voltage is supplied, and a second power line to which a second power voltage is supplied; a second pixel which is connected to a second scan line, the data line, the first power line, and the second power line; a gate driving circuit configured to supply a first scan signal and a second scan signal to the first scan line and the second scan line, respectively; and a data driver configured to supply a data signal to the data line, and when any one of the first scan signal and the second scan signal has a turn-on level, the other one can have a turn-off level.

Other detailed matters of the example embodiments are included in the detailed description and the drawings.

According to the example embodiment of the present disclosure, the display panel is divided into areas to independently control a driving mode of each area to drive each area in a first mode in which contents are provided at a wide viewing angle or a second mode in which contents are provided at a narrow viewing angle.

The effects according to the example embodiments of the present disclosure are not limited to the contents exemplified above, and more various effects are included in the present specification.

Further, the advantages and effects of the present disclosure are not limited to the aforementioned advantages and effects, and other advantages and effects, which are not mentioned above, will be apparently understood to a person having ordinary skill in the art from the following description.

The benefits to be achieved by the present disclosure, the means for achieving the benefits, and the effects of the present disclosure described above do not specify essential features of the claims, and, thus, the scope of the claims is not limited to the disclosure of the present disclosure.

It is to be understood that both the foregoing general description and the following detailed description of the present disclosure are example and explanatory and are intended to provide further explanation of the inventive concepts as claimed.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an example view of a display device according to an example embodiment of the present disclosure;

FIG. 2 is a functional block diagram of a display device according to an example embodiment of the present disclosure;

FIG. 3 is a view illustrating an example of a pixel unit included in a display panel of the display device of FIG. 2;

FIG. 4A is a circuit diagram illustrating an example of a pixel circuit of a first pixel included in the pixel unit of FIG. 3;

FIG. 4B is a circuit diagram illustrating an example of a pixel circuit of a second pixel included in the pixel unit of FIG. 3;

FIGS. 5A and 5B are waveform charts for explaining an example of an operation of the pixel circuit of FIG. 4A and the pixel circuit of FIG. 4B;

FIG. 6A is a circuit diagram illustrating another example of a pixel circuit of a first pixel included in the pixel unit of FIG. 3;

FIG. 6B is a circuit diagram illustrating another example of a pixel circuit of a second pixel included in the pixel unit of FIG. 3;

FIGS. 7A and 7B are waveform charts for explaining an example of an operation of the pixel circuit of FIG. 6A and the pixel circuit of FIG. 6B;

FIGS. 8A and 8B are waveform charts for explaining another example of an operation of the pixel circuit of FIG. 6A and the pixel circuit of FIG. 6B;

FIGS. 9 and 10 are cross-sectional views of a part of a display device according to an example embodiment of the present disclosure;

FIG. 11 is a block diagram illustrating a gate driving circuit according to an example embodiment of the present disclosure;

FIG. 12 is a circuit diagram illustrating an example of a stage circuit included in the gate driving circuit of FIG. 11;

FIGS. 13A and 13B are waveform charts for explaining an example of an operation of the stage circuit of FIG. 12;

FIG. 14 is a waveform chart for explaining an example of an operation of the gate driving circuit of FIG. 11;

FIG. 15 is a circuit diagram illustrating another example of a stage circuit included in the gate driving circuit of FIG. 11;

FIG. 16 is a circuit diagram illustrating still another example of a stage circuit included in the gate driving circuit of FIG. 11;

FIGS. 17A and 17B are waveform charts for explaining an example of an operation of the stage circuit of FIG. 16;

FIG. 18 is a circuit diagram illustrating still another example of a stage circuit included in the gate driving circuit of FIG. 11;

FIG. 19 is a circuit diagram illustrating still another example of a stage circuit included in the gate driving circuit of FIG. 11; and

FIG. 20 is a circuit diagram illustrating still another example of a stage circuit included in the gate driving circuit of FIG. 11.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Any implementation described herein as an “example” is not necessarily to be construed as preferred or advantageous over other implementations.

When the relation of a time sequential order is described using the terms such as “after”, “continuously to”, “next to”, and “before”, the order may not be continuous unless the terms are used with the term “immediately” or “directly”.

In describing components of the example embodiments of the present disclosure, terminologies such as first, second, A, B, (a), (b), and the like can be used. These terminologies are used to distinguish a component from the other component, but a nature, an order, or the number of the components is not limited by the terminology. When a component is “linked”, “coupled”, or “connected” to another component, the component can be directly linked or connected to the other component. However, unless specifically stated otherwise, it can be understood that a third component can be interposed between the components which can be indirectly linked or connected.

It can be understood that “at least one” includes all combinations of one or more of associated components. For example, “at least one of first, second, and third components” means that not only a first, second, or third component, but also all combinations of two or more of first, second, and third components are included.

In the present specification, a “display device” can include a display device which includes a display panel and a driver for driving the display panel, in a narrow sense, such as a liquid crystal module (LCM), an organic light emitting module (OLED module), and a quantum dot (QD) module. Further, the “display device” can further include a set electronic apparatus or a set apparatus (or a set device) which is a complete product or a final product including an LCM, an OLED module, a QD module, etc., such as a notebook computer, a television, or a computer monitor, an automotive display device or equipment display device including another type of vehicle and a mobile electronic apparatus including a smart phone or an electronic pad.

Accordingly, the display device of the present disclosure can include not only a display device itself in a narrow sense such as an LCM, an OLED module, a QD module, etc., but also an applied product or a set apparatus which is a final consumer device including the LCD (liquid crystal display), the OLED module, the QD module, etc.

Further, in some cases, the LCM, the OLED module, or the QD module which is configured by a display panel and a driver can be represented as “a display device” in a narrow sense and an electronic device as a complete product including the LCM, the OLED module, and the QD module can be represented as a “set apparatus”. For example, the display device in the narrow sense includes a liquid crystal display (LCD) panel, an OLED display panel, or a quantum dot (QD) display panel and a source printed circuit board (PCB) which is a controller for driving the display panel. In contrast, the set apparatus can be a concept further including a set PCB which is a set controller which is electrically connected to the source PCB to control the entire set apparatus.

As a display panel used in the example embodiment of the present disclosure, any type of display panel such as a liquid crystal display panel, an organic light emitting diode (OLED) display panel, a quantum dot (QD) display panel, and an electroluminescent display panel can be used. The display panel of the present example embodiment is not limited to a specific display panel in which a bezel is bent with a flexible substrate for the organic light emitting diode (OLED) display panel and a back plate support structure therebelow. Further, a display panel used for the display device according to the example embodiment of the present disclosure is not limited to a shape or a size of the display panel.

For example, when the display panel is an OLED display panel, the display panel can include a plurality of gate lines, data lines, and pixels formed at intersecting areas of the gate lines and/or data lines. Further, the display panel can be configured to include an array including a thin film transistor which is an element to selectively apply a voltage to each pixel, a light emitting diode layer on the array, an encapsulation substrate or an encapsulation layer, and the like disposed on the array so as to cover the light emitting diode layer. The encapsulation layer can protect the thin film transistor, the light emitting diode layer, and the like from external impacts and can suppress the permeation of moisture or oxygen into the light emitting diode layer. Further, a layer formed on the array can include an inorganic light emitting layer, for example, a nano-sized material layer quantum dots, or the like.

The features of various example embodiments of the present disclosure can be partially or entirely coupled to or combined with each other and can be interlocked and operated in technically various ways, and the example embodiments can be carried out independently of or in association with each other. Further, the term “can” fully encompasses all the meanings and coverages of the term “may.”

Hereinafter, the example embodiments of the present disclosure will be described with reference to the accompanying drawings and example embodiments as follows. Scales of components illustrated in the accompanying drawings are different from the real scales for the purpose of description, so that the scales are not limited to those illustrated in the drawings.

Hereinafter, the example embodiments of the present disclosure will be described in detail with reference to the drawings. All the components of each device/apparatus according to all embodiments of the present disclosure are operatively coupled and configured.

Advantages and characteristics of the present disclosure, and a method of achieving the advantages and characteristics will be clear by referring to example embodiments described below in detail together with the accompanying drawings. However, the present disclosure is not limited to example embodiments disclosed herein but will be implemented in various forms. Only these example embodiments are provided to make the disclosure of this specification complete, and to fully inform those skilled in the art of the scope of the specification to which this specification belongs.

The shapes, sizes, ratios, angles, numbers, and the like illustrated in the accompanying drawings for describing the example embodiments of the present disclosure are merely examples, and the present disclosure is not limited thereto. Like reference numerals generally denote like elements throughout the specification. Further, in the following description, a detailed explanation of known related technologies can be omitted or can be briefly provided to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise.

Components are interpreted to include an ordinary error range even if not expressly stated.

When the position relation between two parts is described using the terms such as “on”, “above”, “below”, and “next”, one or more parts can be positioned between the two parts unless the terms are not used with the term “immediately” or “directly”.

When an element or layer is disposed “on” another element or layer, another layer (or layers) or another element (or elements) can be interposed directly on the other element or therebetween.

Although the terms “first”, “second”, and the like are used for describing various components, these components are not confined by these terms. These terms are merely used for distinguishing one component from the other components, and may not define order or sequence. Therefore, a first component to be mentioned below can be a second component in a technical concept of the present disclosure.

A size and a thickness of each component illustrated in the drawings are illustrated for convenience of description, and the present disclosure is not limited to the size and the thickness of the component illustrated.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” can apply, for example, to a separate circuit or structure, an integrated circuit, a computational block of a circuit device, or any structure configured to perform a described function as should be understood to one of ordinary skill in the art.

Rather, these embodiments can be provided so that this disclosure can be sufficiently thorough and complete to assist those skilled in the art to fully understand the scope of the present disclosure. Furthermore, the present disclosure is only defined by scopes of claims.

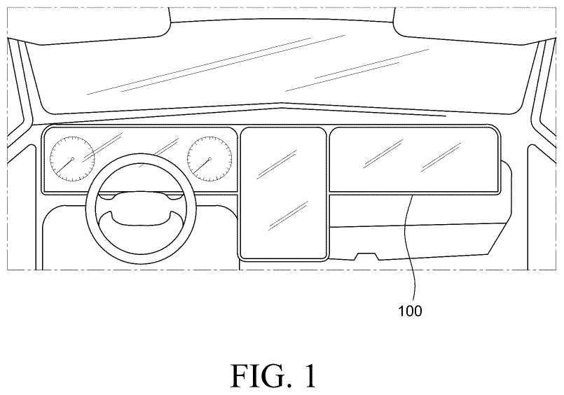

Hereinafter, the present disclosure will be described in detail with reference to the drawings. FIG. 1 is an example view of a display device according to an example embodiment of the present disclosure.

Referring to FIG. 1, a display device 100 can be disposed in at least a part of a dash board of a vehicle or other medium, or can be disposed independently. The dash board of the vehicle can include a configuration disposed in a front surface of front seats (for example, a driver seat and a front passenger seat) of the vehicle. For example, on the dash board of the vehicle, an input configuration for manipulating various functions (for example, an air-conditioner, an audio system, or a navigation system) in the vehicle can be disposed.

The display device 100 is disposed on the dash board of the vehicle to operate as an input unit which manipulates at least a part of various functions of the vehicle. The display device 100 can provide various information related to the vehicle, for example, operation information of the vehicle (for example, a current speed of the vehicle, a remaining fuel amount, or a mileage) or information about parts of the vehicle (for example, a damage level of a vehicle tire).

The display device 100 can be disposed across the driver seat and the front passenger seat disposed in the front seats of the vehicle. A user of the display device 100 can include a driver of the vehicle and a passenger riding on the front passenger seat. Both the vehicle driver and the passenger use the display device 100.

A part of the display device 100 can be illustrated in FIG. 1. The display device 100 illustrated in FIG. 1 can illustrate a display panel, among various configurations included in the display device 100. Specifically, for example, the display device 100 illustrated in FIG. 1 can illustrate at least a part of an active area and a non-active area of the display panel. Among the configurations of the display device 100, configurations other than the parts illustrated in FIG. 1 can be mounted inside the vehicle (or at least a part of the inside of the vehicle).

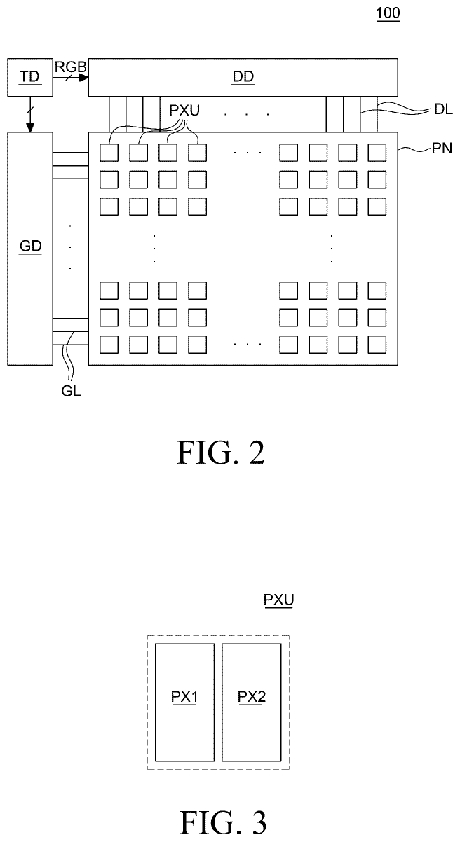

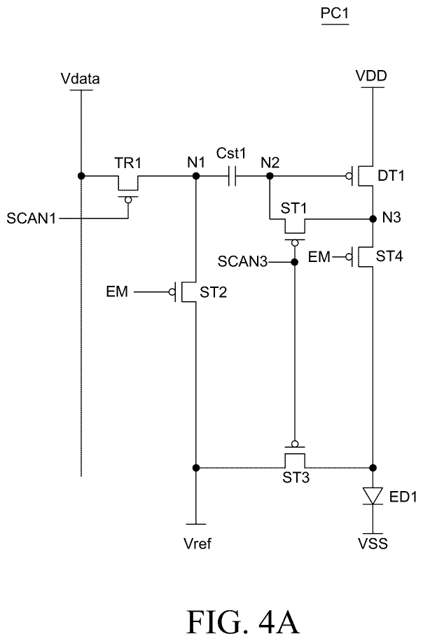

FIG. 2 is a functional block diagram of a display device according to an example embodiment of the present disclosure. FIG. 3 is a view illustrating an example of a pixel unit included in a display panel of a display device of FIG. 2.

As the display device according to the example embodiment of the present disclosure, an electroluminescent display device can be applied. The electroluminescent display device can use an organic light emitting diode (OLED) display device, a quantum dot light emitting diode display device, or an inorganic light emitting diode display device.

Referring to FIG. 2, the display device 100 can include a display panel PN, a data driving circuit DD, a gate driving circuit GD, and a timing controller TD.

The display panel PN can generate images to be provided to the user. For example, the display panel PN can generate and display images to be provided to the user through a plurality of pixel units PXU.

The data driving circuit DD, the gate driving circuit GD, and the timing controller TD can provide signals for operations of the pixel units PXU through signal lines. For example, signal lines for supplying a signal for operation of each pixel unit PXU can include a plurality of data lines DL and a plurality of gate lines GL.

The plurality of data lines DL is disposed in a column direction and can include a plurality of wiring lines connected to pixel units PXU disposed in one column direction and the plurality of gate lines GL is disposed in a row direction and can include a plurality of wiring lines connected to pixel units PXU disposed in one row direction.

In some cases, the display device 100 can further include a power unit. In this case, a signal for an operation of the pixel unit PXU can be supplied through the power line which connects the power unit and the display panel PN. According to the example embodiment, the power unit can supply a power to the data driving circuit DD and the gate driving circuit GD. The data driving circuit DD and the gate driving circuit GD can be driven based on the power supplied from the power unit.

For example, the data driving circuit DD can apply a data voltage to each pixel unit PXU through the plurality of data lines DL. The gate driving circuit GD can apply a gate signal to each pixel unit PXU through the plurality of gate lines GL. The power unit can supply a power voltage to each pixel unit PXU through the power voltage supply lines.

The timing controller TD can control the data driving circuit DD and the gate driving circuit GD. For example, the timing controller TD rearranges digital video data input from the outside in accordance with a resolution of the display panel PN to supply the digital video data to the data driving circuit DD.

The data driving circuit DD converts digital video data input from the timing controller TD into an analog data voltage based on the data control signal to supply the converted analog data voltage to the plurality of data lines DL.

The gate driving circuit GD can generate a scan signal and an emission signal based on the gate control signal. For example, the gate driving circuit GD can include a scan driver and an emission signal driver. The scan driver generates a scan signal in a row sequential manner to drive at least one scan line connected to each pixel row to supply the scan signal to the scan lines. The emission signal driver generates an emission signal in a row sequential manner to drive at least one emission line connected to each pixel row to supply the emission signal to the emission lines.

According to the example embodiment, the gate driving circuit GD can be disposed in the display panel PN in a gate-driver in panel (GIP) manner. For example, the gate driving circuit GD is divided into a plurality of circuits to be disposed on at least two side surfaces of the display panel PN, respectively.

The display panel PN can include an active area and a non-active area which encloses the active area.

The active area of the display panel PN can include a plurality of pixel units PXU disposed in a row direction and a column direction. For example, the plurality of pixel units PXU can be disposed in an area where the plurality of data lines DL and the plurality of gate lines GL intersect.

Each of the plurality of pixel units PXU can include two pixels in which pixel circuits are disposed, respectively. For example, further referring to FIG. 3, each of the plurality of pixel units PXU can include a first pixel PX1 and a second pixel PX2.

The first pixel PX1 and the second pixel PX2 can include the substantially same pixel circuit. A first light emitting diode included in the first pixel PX1 and a second light emitting diode included in the second pixel PX2 can emit the same or substantially same color light.

The first pixel PX1 can include a first optical member which refracts light from the first light emitting diode in a specific direction and a second optical member which refracts light from the second light emitting diode in a specific direction. For example, the first optical member and the second optical member can be implemented as lenses, respectively, but the example embodiment of the present disclosure is not limited thereto.

For example, the first optical member can be disposed in an optical area in which light is provided in a first range to form a first viewing angle and the second optical member can be disposed in an optical area in which light is provided in a second range to form a second viewing angle. The first range can be larger than the second range. Therefore, the first optical member can restrict a viewing angle of the first pixel PX1 and the second optical member can restrict a viewing angle of the second pixel PX2.

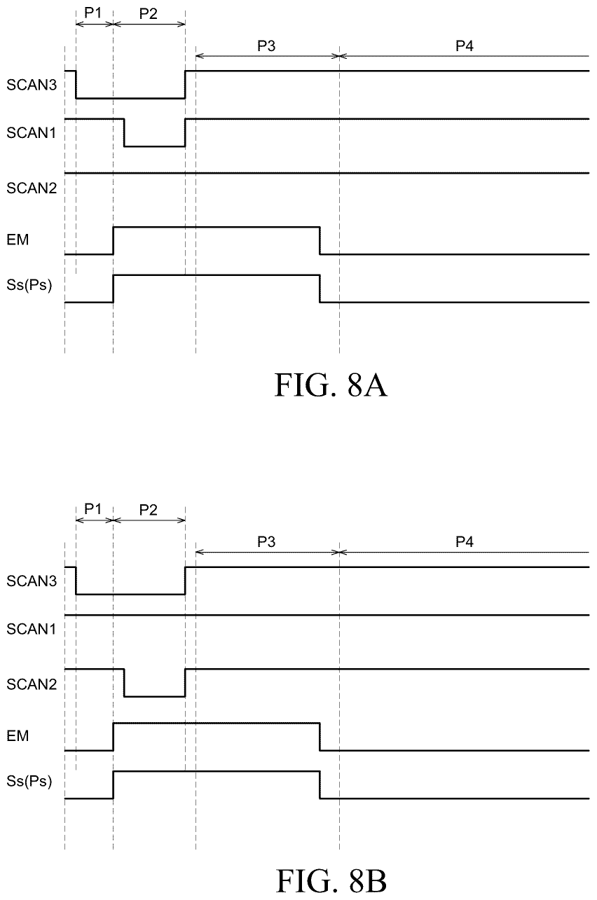

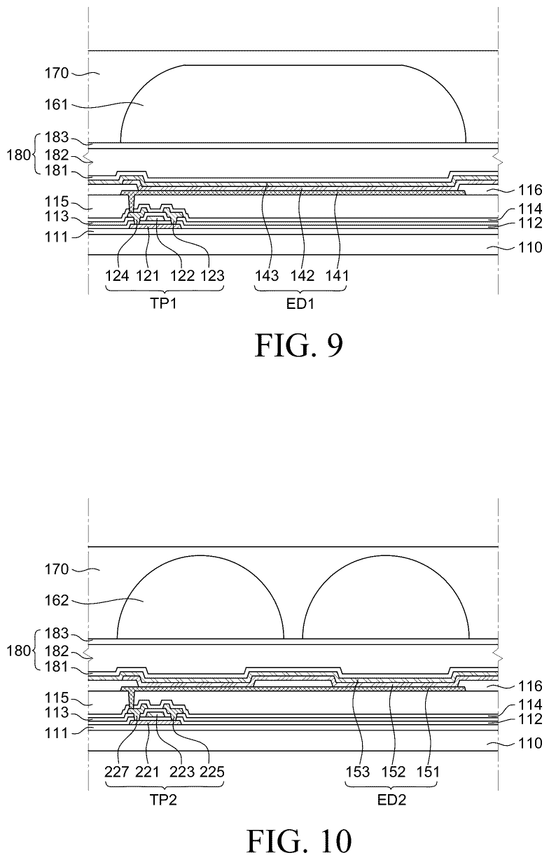

The first optical member and the second optical member will be described in detail below with reference to FIGS. 9 and 10.

Referring to FIG. 2, according to the example embodiment, one pixel unit PXU can emit different color light. For example, one pixel unit PXU can implement any one of blue, red, and green. In this case, the first pixel PX1 and the second pixel PX2 included in the corresponding pixel unit PXU can include a light emitting diode configured to emit light with the same or substantially same color as a color implemented by the pixel unit PXU. For example, the first pixel PX1 can include a first light emitting diode configured to emit light with the same or substantially same color as a color implemented by the corresponding pixel unit PXU and the second pixel PX2 can include a second light emitting diode configured to emit light with the same or substantially same color as a color implemented by the corresponding pixel unit PXU. However, it is not limited thereto and, in some cases, the pixel unit PXU can further implement a specific color, for example, white.

The non-active area can be disposed along the circumference of the active area. In the non-active area, various components for driving pixel circuits of the first pixel PX1 and the second pixel PX2 included in the pixel unit PXU can be disposed. For example, at least a part of the gate driving circuit GD can be disposed in the non-active area. The non-active area can be referred to as a bezel area.

When the display panel PN is used for the vehicle which has been described with reference to FIG. 1, a field of view of at least a partial area of the display panel PN needs to be restricted according to the user's request. For example, images displayed in an area of an active area of the display panel PN which provides an entertainment function and seat information for the passenger sitting on the front passenger seat can interfere with the driving of the driver. Accordingly, according to the user's request, a field of view of the image displayed in the corresponding area needs to be restricted.

Accordingly, each pixel unit PXU included in the display panel PN can be driven in a first mode or a second mode, according to the driving mode. For example, when the pixel unit PXU is driven in the first mode, a first light emitting diode included in a first pixel PX1 emits light based on a scan signal and/or a selection signal to provide light from the first light emitting diode in a first range through the first optical member, to form a first viewing angle, for example, a wide viewing angle. In this case, the second light emitting diode included in the second pixel PX2 may not emit light. Further, when the pixel unit PXU is driven in the second mode, a second light emitting diode included in a second pixel PX2 emits light based on a scan signal and/or a selection signal to provide light from the second light emitting diode in a second range through the second optical member, to form a second viewing angle, for example, a narrow viewing angle. In this case, the first light emitting diode included in the first pixel PX1 may not emit light. Here, the first mode can correspond to a mode in which the pixel unit PXU is controlled in a wide field-of-view mode (share mode) and the second mode can correspond to a mode in which the pixel unit PXU is driven in a narrow field-of-view mode (private mode). Further, the driving mode can be specified by the user's input or determined when a predetermined condition is satisfied.

To be more specific, in the first mode, a first scan transistor connected to the data line DL, among a plurality of transistors included in the first pixel PX1 including the first light emitting diode, is turned on so that a data voltage of a corresponding frame is written in the first pixel PX1. Therefore, the first light emitting diode emits light to provide light from the first light emitting diode in the first range by means of the first optical member to form a first viewing angle, for example, a wide viewing angle. In the meantime, in the first mode as described above, a second scan transistor connected to the data line DL, among a plurality of transistors included in a second pixel PX2 including a second light emitting diode, is turned off or is maintained in a turned-off state so that the data voltage of the corresponding frame is not written in the second pixel PX2. Therefore, in the first mode, the second light emitting diode included in the second pixel PX2 may not emit light.

Further, in the second mode, a second scan transistor connected to the data line DL, among a plurality of transistors included in the second pixel PX2 including the second light emitting diode, is turned on so that a data voltage of a corresponding frame is written in the second pixel PX2. Therefore, the second light emitting diode emits light to provide light from the second light emitting diode in the second range by means of the second optical member to form a second viewing angle, for example, a narrow viewing angle. In the meantime, in the second mode as described above, a first scan transistor connected to the data line DL, among a plurality of transistors included in a first pixel PX1 including a first light emitting diode, is turned off or is maintained in a turned-off state so that the data voltage of the corresponding frame is not written in the first pixel PX1. Therefore, in the second mode, the first light emitting diode included in the first pixel PX1 may not emit light.

As described above, any one pixel, between the first pixel PX1 and the second pixel PX2 included in the pixel unit PXU, emits light according to the driving mode so that the pixel unit PXU can be driven in the first mode or can be driven in the second mode.

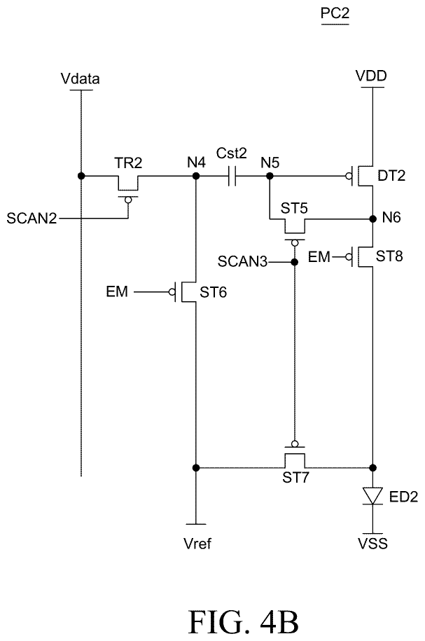

FIG. 4A is a circuit diagram illustrating an example of a pixel circuit of a first pixel included in the pixel unit of FIG. 3. FIG. 4B is a circuit diagram illustrating an example of a pixel circuit of a second pixel included in the pixel unit of FIG. 3.

In the meantime, a first pixel circuit PC1 illustrated in FIG. 4A represents an example of a pixel circuit corresponding to a first pixel PX1 included in each of the plurality of pixel units PXU included in the display device 100 which has been described with reference to FIGS. 2 and 3.

Further, a second pixel circuit PC2 illustrated in FIG. 4B represents an example of a pixel circuit corresponding to a second pixel PX2 included in each of the plurality of pixel units PXU included in the display device 100 which has been described with reference to FIGS. 2 and 3.

Referring to FIGS. 4A and 4B, except that a first pixel circuit PC1 included in the first pixel PX1 is connected to a first scan line applied with a first scan signal SCAN1 and a second pixel circuit PC2 included in the second pixel PX2 is connected to a second scan line applied with a second scan signal SCAN2, the first pixel circuit PC1 and the second pixel circuit PC2 have a substantially similar circuit structure. For example, the first pixel circuit PC1 and the second pixel circuit PC2 are commonly connected to a third scan line applied with a third scan signal SCAN3, an emission line applied with an emission signal EM, a high potential power line applied with a high potential power voltage VDD, and a low potential power line applied with a low potential power voltage VSS. Further, a connection relationship of a transistor, a capacitor, and a light emitting diode can be substantially similar.

In the meantime, in the present disclosure, the high potential power voltage VDD can be defined as a first power voltage and the low potential power voltage VSS can be defined as a second power voltage having a voltage level which is lower than that of the first power voltage. Therefore, the high potential power line can be defined as a first power line and the low potential power line can be defined as a second power line.

Further, referring to FIGS. 4A and 4B, at least some of a plurality of transistors included in the first pixel circuit PC1 and a plurality of transistors included in the second pixel circuit PC2 can be a n-type transistor or a p-type transistor. In the case of the p-type transistor, a low level voltage of each driving signal can refer to a voltage which turns on a TFT and a high level voltage of each driving signal can refer to a voltage which turns off the TFT.

Here, the low level voltage can correspond to a predetermined voltage which is lower than the high level. For example, the low level voltage can include a voltage corresponding to a range of −8 V to −12 V. The high level voltage can correspond to a predetermined voltage which is higher than the low level voltage. For example, the high level voltage can include a voltage corresponding to the range of 12 V to 16 V. According to the example embodiment, the low level voltage can be referred to as a first voltage and the high level voltage can be referred to as a second voltage. In this case, the first voltage can be lower than the second voltage.

First, the first pixel circuit PC1 will be described with reference to FIG. 4A. The first pixel circuit PC1 can include a first driving transistor DT1, a first scan transistor TR1, a plurality of switching transistors ST1 to ST4, a first storage capacitor Cst1, and a first light emitting diode ED1.

The first driving transistor DT1 can control a first driving current applied to the first light emitting diode ED1 in accordance with a source-gate voltage. The first driving transistor DT1 can include a source electrode connected to a high potential power line configured to supply a high potential power voltage VDD, a gate electrode connected to a second node N2, and a drain electrode connected to a third node N3.

The first scan transistor TR1 can apply a data voltage Vdata from the data line DL to the first node N1. The first scan transistor TR1 can include a source electrode connected to the data line DL, a drain electrode connected to the first node N1, and a gate electrode connected to a first scan line to which a first scan signal SCAN1 is applied. The first scan transistor TR1 can be turned on or turned off by the first scan signal SCAN1. Accordingly, the first scan transistor TR1 can apply a data voltage Vdata from the data line DL to the first node N1, in response to a low level of first scan signal SCAN1 which is a turn-on level.

For example, as described with reference to FIGS. 2 and 3, when the pixel unit PXU including the first pixel PX1 operates in the first mode, a turn-on level of first scan signal SCAN1 is supplied to the first pixel PX1 to turn on the first scan transistor TR1. Therefore, the data voltage Vdata supplied from the data line DL can be supplied to the first node N1.

In the meantime, when the pixel unit PXU including the first pixel PX1 operates in a second mode, the first scan signal SCAN1 is maintained at a high level which is a turn-off level so that the first scan transistor TR1 is turned off or maintains a turned-off state in a corresponding frame. Therefore, the data voltage Vdata is not supplied to the first node N1.

The first switching transistor ST1 can diode-connect the gate electrode and the drain electrode of the first driving transistor DT1. The first switching transistor ST1 can include a drain electrode connected to the second node N2, a source electrode connected to the third node N3, and a gate electrode connected to a third scan line to which a third scan signal SCAN3 is applied. The first switching transistor ST1 can be turned on or turned off by the third scan signal SCAN3. Therefore, the first switching transistor ST1 can diode-connect the gate electrode and the drain electrode of the first driving transistor DT1 in response to a low level of third scan signal SCAN3 which is a turn-on level.

The second switching transistor ST2 can apply a reference voltage Vref to the first node N1. The second switching transistor ST2 can include a source electrode which is connected to the reference voltage line configured to supply the reference voltage Vref, a drain electrode which is connected to the first node N1, and a gate electrode which is connected to the emission line to which the emission signal EM is applied. The second switching transistor ST2 can be turned on or turned off by the emission signal EM. Accordingly, the second switching transistor ST2 can transmit the reference voltage Vref to the first node N1 in response to a low level of emission signal EM which is a turn-on level.

The third switching transistor ST3 can apply the reference voltage Vref to the anode electrode of the first light emitting diode ED1. The third switching transistor ST3 can include a source electrode connected to the reference voltage line, a drain electrode connected to an anode electrode of the first light emitting diode ED1, and a gate electrode connected to the third scan line. The third switching transistor ST3 can be turned on or turned off by the third scan signal SCAN3. Therefore, the third switching transistor ST3 can apply the reference voltage Vref to the anode electrode of the first light emitting diode ED1 in response to the low level of third scan signal SCAN3 which is a turn-on level.

The fourth switching transistor ST4 can form a current path between the first driving transistor DT1 and the first light emitting diode ED1. The fourth switching transistor ST4 can include a source electrode connected to the third node N3, a drain electrode connected to an anode electrode of the first light emitting diode ED1, and a gate electrode connected to the emission line. The fourth switching transistor ST4 can be turned on or turned off by the emission signal EM. Therefore, the fourth switching transistor ST4 electrically connects the third node N3 and the anode electrode of the first light emitting diode ED1 in response to a low level of emission signal EM which is a turn-on level to form a current path between the first driving transistor DT1 and the first light emitting diode ED1.

The first storage capacitor Cst1 can include a first electrode connected to the first node N1 and a second electrode connected to the second node N2. One electrode of the first storage capacitor Cst1 can be connected to the gate electrode of the first driving transistor DT1 and the other electrode of the first storage capacitor Cst1 can be connected to the first scan transistor TR1. The first storage capacitor Cst1 stores a predetermined voltage to constantly maintain a voltage of the gate electrode of the first driving transistor DT1 while the first light emitting diode ED1 emits light.

The first light emitting diode ED1 can be connected between the fourth switching transistor ST4 and the low potential power line configured to supply a low potential power voltage VSS. In this case, the first light emitting diode ED1 can be connected to another configuration of the first pixel circuit PC1, for example, the first driving transistor DT1 via the fourth switching transistor ST4 which is turned on by a turn-on level of emission signal EM.

At this time, as described above, when the pixel unit PXU including the first pixel PX1 operates in the first mode, the data voltage Vdata is supplied to the first node N1 of the first pixel PX1 by the first scan transistor TR1 which is turned on in the corresponding frame. Accordingly, the first driving transistor DT1 can generate a first driving current by the source-gate voltage. Such a first driving current can be supplied to the first light emitting diode ED1 from the first driving transistor DT1 via the fourth switching transistor ST4 and the first light emitting diode ED1 can emit light by the first driving current. Accordingly, in the first mode, light can be supplied from the pixel unit PXU at a wide viewing angle, which is a first viewing angle.

In the meantime, when the pixel unit PXU including the first pixel PX1 operates in the second mode, the first scan transistor TR1 is turned off or maintains a turned-off state in the corresponding frame so that the data voltage Vdata is not supplied to the first node N1. Therefore, the first driving current is not generated from the first driving transistor DT1. Accordingly, the first driving current is not supplied to the first light emitting diode ED1 in the second mode so that the first light emitting diode ED1 may not emit light.

Next, the second pixel circuit PC2 will be described with reference to FIG. 4B. The second pixel circuit PC2 can include a second driving transistor DT2, a second scan transistor TR2, a plurality of switching transistors ST5 to ST8, a second storage capacitor Cst2, and a second light emitting diode ED2.

The second driving transistor DT2 can control a second driving current applied to the second light emitting diode ED2 in accordance with a source-gate voltage. The second driving transistor DT2 can include a source electrode connected to a high potential power line configured to supply a high potential power voltage VDD, a gate electrode connected to a fifth node N5, and a drain electrode connected to a sixth node N6.

The second scan transistor TR2 can apply a data voltage Vdata to the fourth node N4 from the data line DL. The second scan transistor TR2 can include a source electrode connected to the data line DL, a drain electrode connected to the fourth node N4, and a gate electrode connected to a second scan line to which a second scan signal SCAN2 is applied. The second scan transistor TR2 can be turned on or turned off by the second scan signal SCAN2. Accordingly, the second scan transistor TR2 can apply a data voltage Vdata from the data line DL to the fourth node N4, in response to a low level of second scan signal SCAN2 which is a turn-on level.

For example, as described with reference to FIGS. 2 and 3, when the pixel unit PXU including the second pixel PX2 operates in the second mode, a turn-on level of second scan signal SCAN2 is supplied to the second pixel PX2 to turn on the second scan transistor TR2. Therefore, the data voltage Vdata supplied from the data line DL can be supplied to the fourth node N4.

In the meantime, when the pixel unit PXU including the second pixel PX2 operates in the first mode, the second scan signal SCAN2 is maintained at a high level which is a turn-off level so that the second scan transistor TR2 is turned off or maintains a turned-off state in a corresponding frame. Therefore, the data voltage Vdata is not supplied to the fourth node N4.

The fifth switching transistor ST5 can diode-connect the gate electrode and the drain electrode of the second driving transistor DT2. The fifth switching transistor ST5 can include a drain electrode connected to the fifth node N5, a source electrode connected to the sixth node N6, and a gate electrode connected to a third scan line. The fifth switching transistor ST5 can be turned on or turned off by the third scan signal SCAN3. Therefore, the fifth switching transistor ST5 can diode-connect the gate electrode and the drain electrode of the second driving transistor DT2 in response to a low level of third scan signal SCAN3 which is a turn-on level.

The sixth switching transistor ST6 can apply a reference voltage Vref to the fourth node N4. The sixth switching transistor ST6 can include a source electrode connected to the reference voltage line, a drain electrode connected to the fourth node N4, and a gate electrode connected to an emission line. The sixth switching transistor ST6 can be turned on or turned off by the emission signal EM. Accordingly, the sixth switching transistor ST6 can transmit the reference voltage Vref to the fourth node N4 in response to a low level of emission signal EM which is a turn-on level.

The seventh switching transistor ST7 can apply the reference voltage Vref to the anode electrode of the second light emitting diode ED2. The seventh switching transistor ST7 can include a source electrode connected to the reference voltage line, a drain electrode connected to an anode electrode of the second light emitting diode ED2, and a gate electrode connected to the third scan line. The seventh switching transistor ST7 can be turned on or turned off by the third scan signal SCAN3. Therefore, the seventh switching transistor ST7 can apply the reference voltage Vref to the anode electrode of the second light emitting diode ED2 in response to the low level of third scan signal SCAN3 which is a turn-on level.

The eighth switching transistor ST8 can form a current path between the second driving transistor DT2 and the second light emitting diode ED2. The eighth switching transistor ST8 can include a source electrode connected to the sixth node N6, a drain electrode connected to an anode electrode of the second light emitting diode ED2, and a gate electrode connected to the emission line. The eighth switching transistor ST8 can be turned on or turned off by the emission signal EM. Therefore, the eighth switching transistor ST8 electrically connects the sixth node N6 and the anode electrode of the second light emitting diode ED2 in response to a low level of emission signal EM which is a turn-on level to form a current path between the second driving transistor DT2 and the second light emitting diode ED2.

The second storage capacitor Cst2 can include a first electrode connected to the fourth node N4 and a second electrode connected to the fifth node N5. One electrode of the second storage capacitor Cst2 can be connected to the gate electrode of the second driving transistor DT2 and the other electrode of the second storage capacitor Cst2 can be connected to the second scan transistor TR2. The second storage capacitor Cst2 stores a predetermined voltage to constantly maintain a voltage of the gate electrode of the second driving transistor DT2 while the second light emitting diode ED2 emits light.

The second light emitting diode ED2 can be connected between the eighth switching transistor ST8 and the low potential power line configured to supply a low potential power voltage VSS. In this case, the second light emitting diode ED2 can be connected to another configuration of the second pixel circuit PC2, for example, the second driving transistor DT2 via the eighth switching transistor ST8 which is turned on by a turn-on level of emission signal EM.

At this time, as described above, when the pixel unit PXU including the second pixel PX2 operates in the second mode, the data voltage Vdata is supplied to the fourth node N4 of the second pixel PX2 by the second scan transistor TR2 which is turned on in the corresponding frame. Accordingly, the second driving transistor DT2 can generate a second driving current by the source-gate voltage. Such a second driving current can be supplied to the second light emitting diode ED2 from the second driving transistor DT2 via the eighth switching transistor ST8 and the second light emitting diode ED2 can emit light by the second driving current. Accordingly, in the second mode, light can be supplied from the pixel unit PXU at a narrow viewing angle, which is a second viewing angle.

In the meantime, when the pixel unit PXU including the second pixel PX2 operates in the first mode, the second scan transistor TR2 is turned off or maintains a turned-off state in the corresponding frame so that the data voltage Vdata is not supplied to the fourth node N4. Therefore, the second driving current is not generated from the second driving transistor DT2. Accordingly, the second driving current is not supplied to the second light emitting diode ED2 in the first mode so that the second light emitting diode ED2 may not emit light.

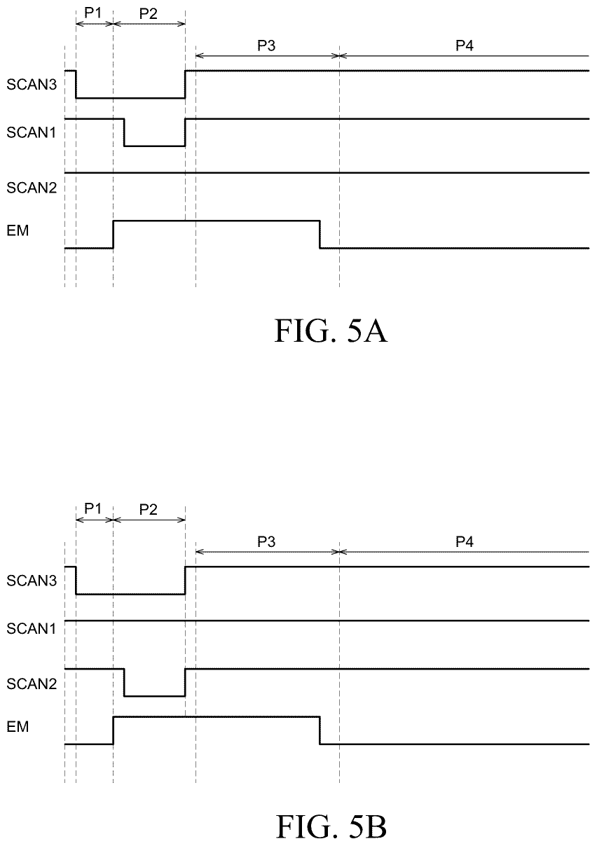

FIGS. 5A and 5B are waveform charts for explaining an example of operations of the pixel circuit of FIG. 4A and the pixel circuit of FIG. 4B.

In the meantime, in FIG. 5A, a waveform chart for explaining an example that the pixel unit PXU including the first pixel PX1 to which the first pixel circuit PC1 is applied and the second pixel PX2 to which the second pixel circuit PC2 is applied is driven in the first mode is illustrated. In FIG. 5B, a waveform chart for explaining an example that the pixel unit PXU including the first pixel PX1 to which the first pixel circuit PC1 is applied and the second pixel PX2 to which the second pixel circuit PC2 is applied is driven in the second mode is illustrated.

Referring to FIGS. 4A to 5B, in the first mode, only the first light emitting diode ED1 included in the first pixel circuit PC1 can emit light and in the second mode, only the second light emitting diode ED2 included in the second pixel circuit PC2 can emit light. Here, as illustrated in FIG. 5A, the second scan signal SCAN2 which applies a data voltage Vdata to the second pixel PX2 to which the second pixel circuit PC2 is applied to allow only the first light emitting diode ED1 to emit light in the first mode can be output only at a high level which is a turn-off level. Further, as illustrated in FIG. 5B, the first scan signal SCAN1 which applies a data voltage Vdata to the first pixel PX1 to which the first pixel circuit PC1 is applied to allow only the second light emitting diode ED2 to emit light in the second mode can be output only at a high level which is a turn-off level.

Accordingly, hereinafter, an operation of the first pixel PX1 included in the pixel unit PXU will be mainly described with reference to FIG. 5A and an operation of the second pixel PX2 included in the pixel unit PXU will be mainly described with reference to FIG. 5B.

In the meantime, in the present disclosure, the high level can be defined as a first level and the low level can be defined as a second level which is lower than the first level.

Specifically, the first mode, which is a wide field-of-view mode will be described with reference to FIGS. 4A, 4B, and 5A. In an initialization period P1, a low level of third scan signal SCAN3 and a low level of emission signal EM can be output. The first switching transistor ST1 and the third switching transistor ST3 can be turned on by the low level of third scan signal SCAN3 and the second switching transistor ST2 and the fourth switching transistor ST4 can be turned on by the low level of emission signal EM.

The first node N1 can be initialized to the reference voltage Vref through the turned-on second switching transistor ST2. A voltage of the anode electrode of the first light emitting diode ED1 can be initialized to the reference voltage Vref by the turned-on third switching transistor ST3. The first driving transistor DT1 is diode-connected by the turned-on first switching transistor ST1 so that the gate electrode and the drain electrode of the first driving transistor DT1 are shorted. Therefore, the first driving transistor DT1 can operate as a diode. The reference voltage Vref which is transmitted to the anode electrode of the first light emitting diode ED1 through the turned-on third switching transistor ST3 is transmitted to the third node N3 and the second node N2 through the turned-on fourth switching transistor ST4 so that the third node N3 and the second node N2 can be initialized to the reference voltage Vref.

Next, during a sampling period P2, the low level of first scan signal SCAN1 and the low level of third scan signal SCAN3 can be output, and the emission signal EM can be output at a high level. A high level of emission signal EM is output so that the second switching transistor ST2 is turned off and the first scan transistor TR1 is turned on by the low level of first scan signal SCAN1, simultaneously, to transmit the data voltage Vdata to the first node N1. The first driving transistor DT1 is diode-connected by the turned-on first switching transistor ST1 and a different voltage of the high potential power voltage VDD and the threshold voltage is sampled to be supplied to the second node N2.

In the meantime, in the sampling period P2, the fourth switching transistor ST4 can be turned off by the high level of emission signal EM.

In a holding period P3, the first scan signal SCAN1 and the third scan signal SCAN3 are output at a high level and all the first scan transistor TR1, the first switching transistor ST1, and the third switching transistor ST3 can be turned off. However, even though the first scan transistor TR1 is turned off, the data voltage Vdata which has been input in the previous period (for example, a sampling period P2) can be maintained by the first storage capacitor Cst1.

Finally, the low level of emission signal EM can be output in the emission period P4. The reference voltage Vref is applied to the first node N1 through the second switching transistor ST2 which is turned on by the low level of emission signal EM and the voltage of the first node N1 can become the different voltage of the reference voltage Vref and the data voltage Vdata. Such voltage fluctuation can be reflected to the second node N2. The gate-source voltage of the first driving transistor DT1 is set to a value Vdata−Vref+Vth obtained by subtracting the reference voltage Vref from the data voltage Vdata and then adding the threshold voltage Vth to control the first driving current.

A first driving current is supplied from the first driving transistor DT1 to the first light emitting diode ED1 through the fourth switching transistor ST4 which is turned on by the low level of emission signal EM to allow the first light emitting diode ED1 to emit light.

However, as described above, in the first mode, the second scan signal SCAN2 is output only at a high level which is a turn-off level so that in the corresponding frame, the second scan transistor TR2 of the second pixel PX2 can be turned off or maintain a turned-off state. Accordingly, the data voltage Vdata of the corresponding frame is not written in the fourth node N4 of the second pixel PX2 and each node of the second pixel PX2 can be maintained at a voltage which is initialized in an initialization period P1 of the previous frame. Accordingly, in the first mode, a second driving current is not generated from the second driving transistor DT2 included in the second pixel PX2 so that the second light emitting diode ED2 may not emit light.

Accordingly, when the pixel unit PXU is driven in the first mode, the first driving current is applied only to the first light emitting diode ED1 so that only the first light emitting diode ED1 can emit light.

Next, the second mode, which is a narrow field-of-view mode will be described with reference to FIGS. 4A, 4B, and 5B. Except that the first scan signal SCAN1 and the second scan signal SCAN2 are output in an opposite manner to in the first mode which is a wide field-of-view mode, the pixel unit PXU can be driven in the second mode, in a substantially same manner as in the first mode. For example, the first scan signal SCAN1 can be output only at a high level which is a turn-off level and the second scan signal SCAN2 can be output at a low level which is a turn-on level during a sampling period P2 in which the data voltage Vdata is written.

Specifically, during the initialization period P1, the low level of third scan signal SCAN3 and the low level of emission signal EM can be output. The fifth switching transistor ST5 and the seventh switching transistor ST7 can be turned on by the low level of third scan signal SCAN3 and the sixth switching transistor ST6 and the eighth switching transistor ST8 can be turned on by the low level of emission signal EM.

The fourth node N4 can be initialized to the reference voltage Vref through the turned-on sixth switching transistor ST6. A voltage of the anode electrode of the second light emitting diode ED2 can be initialized to the reference voltage Vref by the turned-on seventh switching transistor ST7. The second driving transistor DT2 is diode-connected by the turned-on fifth switching transistor ST5 so that the gate electrode and the drain electrode of the second driving transistor DT2 are shorted. Therefore, the second driving transistor DT2 can operate as a diode. The reference voltage Vref which is transmitted to the anode electrode of the second light emitting diode ED2 through the turned-on seventh switching transistor ST7 is transmitted to the sixth node N6 and the fifth node N5 through the turned-on eighth switching transistor ST8 so that the sixth node N6 and the fifth node N5 can be initialized to the reference voltage Vref.

Next, in the sampling period P2, the low level of second scan signal SCAN2 and the low level of third scan signal SCAN3 can be output, and the emission signal EM can be output at a high level. A high level of emission signal EM is output so that the sixth switching transistor ST6 is turned off and the second scan transistor TR2 is turned on by the low level of second scan signal SCAN2, simultaneously, to transmit the data voltage Vdata to the fourth node N4. The second driving transistor DT2 is diode-connected by the turned-on fifth switching transistor ST5 and a different voltage of the high potential power voltage VDD and the threshold voltage is sampled to be supplied to the fifth node N5.

In the meantime, in the sampling period P2, the eighth switching transistor ST8 can be turned off by the high level of emission signal EM.

In a holding period P3, the second scan signal SCAN2 and the third scan signal SCAN3 can be output at a high level and all the second scan transistor TR2, the fifth switching transistor ST5, and the seventh switching transistor ST7 can be turned off. However, even though the second scan transistor TR2 is turned off, the data voltage Vdata which has been input in the previous period (for example, a sampling period P2) can be maintained by the second storage capacitor Cst2.

Finally, the low level of emission signal EM can be output in the emission period P4. The reference voltage Vref is applied to the fourth node N4 through the sixth switching transistor ST6 which is turned on by the low level of emission signal EM and the voltage of the fourth node N4 can become the different voltage of the reference voltage Vref and the data voltage Vdata. Such voltage fluctuation can be reflected to the sixth node N6. The gate-source voltage of the second driving transistor DT2 is set to a value Vdata−Vref+Vth obtained by subtracting the reference voltage Vref from the data voltage Vdata and then adding the threshold voltage Vth to control the second driving current.

A second driving current is supplied from the second driving transistor DT2 to the second light emitting diode ED2 through the eighth switching transistor ST8 which is turned on by the low level of emission signal EM to allow the second light emitting diode ED2 to emit light.

However, as described above, in the second mode, the first scan signal SCAN1 is output only at a high level which is a turn-off level so that in the corresponding frame, the first scan transistor TR1 of the first pixel PX1 can be turned off or maintain a turned-off state. Accordingly, the data voltage Vdata of the corresponding frame is not written in the first node N1 of the first pixel PX1 and each node of the first pixel PX1 can be maintained at a voltage which is initialized in an initialization period P1 of the previous frame. Accordingly, in the second mode, a first driving current is not generated from the first driving transistor DT1 included in the first pixel PX1 so that the first light emitting diode ED1 may not emit light.

Accordingly, when the pixel unit PXU is driven in the second mode, the second driving current is applied only to the second light emitting diode ED2 so that only the second light emitting diode ED2 can emit light.

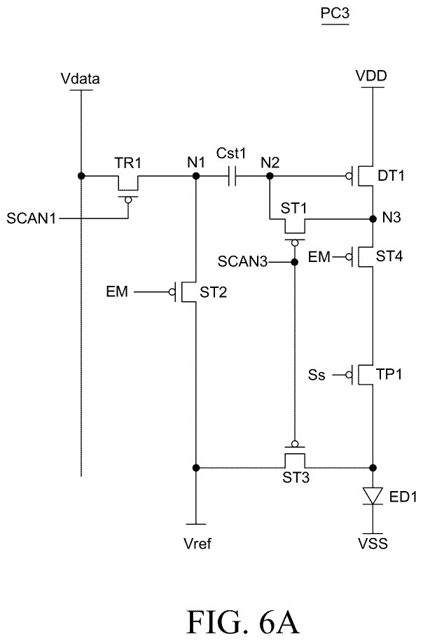

FIG. 6A is a circuit diagram illustrating another example of a pixel circuit of a first pixel included in the pixel unit of FIG. 3. FIG. 6B is a circuit diagram illustrating another example of a pixel circuit of a second pixel included in the pixel unit of FIG. 3.

In the meantime, a third pixel circuit PC3 illustrated in FIG. 6A represents another example of a pixel circuit corresponding to a first pixel PX1 included in each of the plurality of pixel units PXU included in the display device 100 which has been described with reference to FIGS. 2 and 3. For example, FIG. 6A illustrates a modified example of the example embodiment of FIG. 4A with regard to a first selection transistor TP1. Specifically, except that the third pixel circuit PC3 of FIG. 6A further includes a first selection transistor TP1, as compared with the first pixel circuit PC1 of FIG. 4A, the third pixel circuit PC3 and the first pixel circuit PC1 are substantially the same or similar, so that a redundant description will not be repeated.

Further, a fourth pixel circuit PC4 illustrated in FIG. 6B represents another example of a pixel circuit corresponding to a second pixel PX2 included in each of the plurality of pixel units PXU included in the display device 100 which has been described with reference to FIGS. 2 and 3. For example, FIG. 6B illustrates a modified example of the example embodiment of FIG. 4B with regard to a second selection transistor TP2. Specifically, except that the fourth pixel circuit PC4 of FIG. 6B further includes a second selection transistor TP2, as compared with the second pixel circuit PC2 of FIG. 4B, the fourth pixel circuit PC4 and the second pixel circuit PC2 are substantially the same or similar, so that a redundant description will not be repeated.

First, the third pixel circuit PC3 will be described with reference to FIG. 6A. The third pixel circuit PC3 can include a first driving transistor DT1, a first scan transistor TR1, a plurality of switching transistors ST1 to ST4, a first storage capacitor Cst1, a first selection transistor TP1, and a first light emitting diode ED1.

The first selection transistor TP1 can generate a current path of the first driving current which is supplied to the first light emitting diode ED1.

The first selection transistor TP1 is connected between the fourth switching transistor ST4 and the first light emitting diode ED1 and a gate electrode of the first selection transistor TP1 can be connected to a first selection signal line configured to supply a first selection signal Ss.

When the pixel unit PXU including the first pixel PX1 to which the third pixel circuit PC3 is applied is driven in a first mode which is a wide field-of-view mode, a first selection signal Ss having a low level which is a turn-on level in the corresponding frame is supplied to a gate electrode of the first selection transistor TP1. Accordingly, the first selection transistor TP1 can be turned on. Therefore, a current path of the first driving current which passes through the first light emitting diode ED1 is formed so that the first light emitting diode ED1 can emit light. In the meantime, the first selection transistor TP1 can be referred to as a first emission control transistor configured to control emission of the first light emitting diode ED1.

Next, the fourth pixel circuit PC4 will be described with reference to FIG. 6B. The fourth pixel circuit PC4 can include a second driving transistor DT2, a second scan transistor TR2, a plurality of switching transistors ST5 to ST8, a second storage capacitor Cst2, a second selection transistor TP2, and a second light emitting diode ED2.

The second selection transistor TP2 can generate a current path of the second driving current which is supplied to the second light emitting diode ED2.

The second selection transistor TP2 can be connected between the eighth switching transistor ST8 and the second light emitting diode ED2 and a gate electrode of the second selection transistor TP2 can be connected to a second selection signal line configured to supply a second selection signal Ps.

When the pixel unit PXU including the second pixel PX2 to which the fourth pixel circuit PC4 is applied is driven in a second mode which is a narrow field-of-view mode, a second selection signal Ps having a low level which is a turn-on level in the corresponding frame is supplied to a gate electrode of the second selection transistor TP2. Accordingly, the second selection transistor TP2 can be turned on. Therefore, a current path of the second driving current which passes through the second light emitting diode ED2 is formed so that the second light emitting diode ED2 can emit light. In the meantime, the second selection transistor TP2 can be referred to as a second emission control transistor configured to control emission of the second light emitting diode ED2.

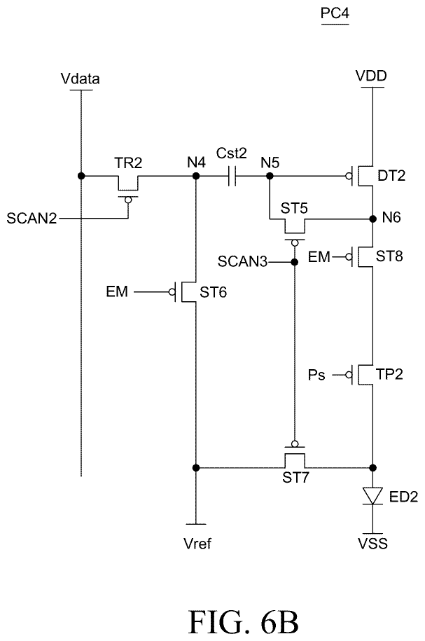

FIGS. 7A and 7B are waveform charts for explaining an example of operations of the pixel circuit of FIG. 6A and the pixel circuit of FIG. 6B.

In the meantime, in FIG. 7A, a waveform chart for explaining an example that the pixel unit PXU including the first pixel PX1 to which the third pixel circuit PC3 is applied and the second pixel PX2 to which the fourth pixel circuit PC4 is applied is driven in the first mode is illustrated. In FIG. 7B, a waveform chart for explaining an example that the pixel unit PXU including the first pixel PX1 to which the third pixel circuit PC3 is applied and the second pixel PX2 to which the fourth pixel circuit PC4 is applied is driven in the second mode is illustrated.

Referring to FIGS. 6A to 7B, in the first mode, only the first light emitting diode ED1 included in the third pixel circuit PC3 can emit light and in the second mode, only the second light emitting diode ED2 included in the fourth pixel circuit PC4 can emit light. Here, as illustrated in FIG. 7A, the second scan signal SCAN2 which applies a data voltage Vdata to the second pixel PX2 to which the fourth pixel circuit PC4 is applied to allow only the first light emitting diode ED1 to emit light in the first mode and the second selection signal Ps configured to control the emission of the second light emitting diode ED2 can be output only at a high level which is a turn-off level. Further, as illustrated in FIG. 7B, the first scan signal SCAN1 which applies a data voltage Vdata to the first pixel PX1 to which the third pixel circuit PC3 is applied to allow only the second light emitting diode ED2 to emit light in the second mode and the first selection signal Ss configured to control the emission of the first light emitting diode ED1 can be output only at a high level which is a turn-off level.

Accordingly, hereinafter, an operation of the first pixel PX1 included in the pixel unit PXU will be mainly described with reference to FIG. 7A and an operation of the second pixel PX2 included in the pixel unit PXU will be mainly described with reference to FIG. 7B.

Specifically, the first mode, which is a wide field-of-view mode will be described with reference to FIGS. 6A, 6B, and 7A. In an initialization period P1, a low level of third scan signal SCAN3, a low level of first selection signal Ss, and a low level of emission signal EM can be output. The first switching transistor ST1 and the third switching transistor ST3 can be turned on by the low level of third scan signal SCAN3 and the first selection transistor TP1 can be turned on by the low level of first selection signal Ss. Further, the second switching transistor ST2 and the fourth switching transistor ST4 can be turned on by the low level of emission signal EM.

Here, as described with reference to FIG. 5A, voltages of the first node N1 and the anode electrode of the first light emitting diode ED1 can be initialized to the reference voltage Vref, through the turned on second switching transistor ST2 and third switching transistor ST3. Further, the first driving transistor DT1 can be diode-connected by the turned-on first switching transistor ST1. The reference voltage Vref which is transmitted to the anode electrode of the first light emitting diode ED1 through the turned-on third switching transistor ST3 is transmitted to the third node N3 and the second node N2 through the turned-on first selection transistor TP1 and fourth switching transistor ST4. Therefore, the third node N3 and the second node N2 can be initialized to the reference voltage Vref.

Next, in a sampling period P2, the low level of first scan signal SCAN1 and the low level of third scan signal SCAN3 can be output and the first selection signal Ss and the emission signal EM can be output at a high level.

Here, as described with reference to FIG. 5A, the second switching transistor ST2 is turned off and the first scan transistor TR1 is turned on by the high level of emission signal EM and the low level of first scan signal SCAN1, simultaneously, to transmit the data voltage Vdata to the first node N1. The first driving transistor DT1 is diode-connected by the turned-on first switching transistor ST1 and a different voltage of the high potential power voltage VDD and the threshold voltage is sampled to be supplied to the second node N2.

In the meantime, in the sampling period P2, the fourth switching transistor ST4 can be turned off by the high level of emission signal EM and the first selection transistor TP1 can be turned off by the high level of first selection signal Ss.

In a holding period P3, the first scan signal SCAN1 and the third scan signal SCAN3 can be output at a high level and all the first scan transistor TR1, the first switching transistor ST1, and the third switching transistor ST3 can be turned off. The data voltage Vdata which has been input in the previous period (for example, a sampling period P2) can be maintained by the first storage capacitor Cst1.

Finally, the low level of first selection signal Ss and the low level of emission signal EM can be output in the emission period P4. The reference voltage Vref is applied to the first node N1 through the second switching transistor ST2 which is turned on by the low level of emission signal EM and the voltage of the first node N1 can become the different voltage of the reference voltage Vref and the data voltage Vdata. Such voltage fluctuation can be reflected to the second node N2. The gate-source voltage of the first driving transistor DT1 is set to a value Vdata−Vref+Vth obtained by subtracting the reference voltage Vref from the data voltage Vdata and then adding the threshold voltage Vth to control the first driving current.

A first driving current is supplied from the first driving transistor DT1 to the first light emitting diode ED1 through the fourth switching transistor ST4 which is turned on by the low level of emission signal EM and the first selection transistor TP1 which is turned on by the low level of first selection signal Ss. Therefore, the first light emitting diode ED1 can emit light.

However, as described above, in the first mode, the second scan signal SCAN2 is output only at a high level which is a turn-off level so that in the corresponding frame, the second scan transistor TR2 of the second pixel PX2 can be turned off or maintain a turned-off state. Accordingly, the data voltage Vdata of the corresponding frame is not written in the fourth node N4 of the second pixel PX2 and each node of the second pixel PX2 can be maintained at a voltage which is initialized in an initialization period P1 of the previous frame. Accordingly, in the first mode, a second driving current is not generated from the second driving transistor DT2 included in the second pixel PX2 so that the second light emitting diode ED2 may not emit light.

Accordingly, when the pixel unit PXU is driven in the first mode, the first driving current is applied only to the first light emitting diode ED1 so that only the first light emitting diode ED1 can emit light.

Further, as described above, in the first mode, the second selection signal Ps for controlling emission of the second light emitting diode ED2 is output only at a high level which is a turn-off level. Therefore, even though an unintended residual current occurs, the second light emitting diode ED2 can maintain a non-emission state in the first mode so that a driving reliability of the pixel unit PXU can be improved.

Next, the second mode, which is a narrow field-of-view mode will be described with reference to FIGS. 6A, 6B, and 7B. In an initialization period P1, a low level of third scan signal SCAN3, a low level of second selection signal Ps, and a low level of emission signal EM can be output. The fifth switching transistor ST5 and the seventh switching transistor ST7 can be turned on by the low level of third scan signal SCAN3 and the second selection transistor TP2 can be turned on by the low level of second selection signal Ps. Further, the sixth switching transistor ST6 and the eighth switching transistor ST8 can be turned on by the low level of emission signal EM.

Here, as described with reference to FIG. 5B, voltages of the fourth node N4 and the anode electrode of the second light emitting diode ED2 can be initialized to the reference voltage Vref, through the turned on sixth switching transistor ST6 and seventh switching transistor ST7. Further, the second driving transistor DT2 can be diode-connected by the turned-on fifth switching transistor ST5. The reference voltage Vref which is transmitted to the anode electrode of the second light emitting diode ED2 through the turned-on seventh switching transistor ST7 is transmitted to the sixth node N6 and the fifth node N5 through the turned-on second selection transistor TP2 and eighth switching transistor ST8. Therefore, the sixth node N6 and the fifth node N5 can be initialized to the reference voltage Vref.

Next, in the sampling period P2, the low level of second scan signal SCAN2 and the low level of third scan signal SCAN3 can be output, and the second selection signal Ps and the emission signal EM can be output at a high level.

Here, as described with reference to FIG. 5B, the sixth switching transistor ST6 is turned off and the second scan transistor TR2 is turned on by the high level of emission signal EM and the low level of second scan signal SCAN2, simultaneously, to transmit the data voltage Vdata to the fourth node N4. The second driving transistor DT2 is diode-connected by the turned-on fifth switching transistor ST5 and a different voltage of the high potential power voltage VDD and the threshold voltage is sampled to be supplied to the fifth node N5.

In the meantime, in the sampling period P2, the eighth switching transistor ST8 can be turned off by the high level of emission signal EM and the second selection transistor TP2 can be turned off by the high level of second selection signal Ps.

In a holding period P3, the second scan signal SCAN2 and the third scan signal SCAN3 can be output at a high level and all the second scan transistor TR2, the fifth switching transistor ST5, and the seventh switching transistor ST7 can be turned off. The data voltage Vdata which has been input in the previous period (for example, a sampling period P2) can be maintained by the second storage capacitor Cst2.

Finally, the low level of second selection signal Ps and the low level of emission signal EM can be output during the emission period P4. The reference voltage Vref is applied to the fourth node N4 through the sixth switching transistor ST6 which is turned on by the low level of emission signal EM and the voltage of the fourth node N4 can become the different voltage of the reference voltage Vref and the data voltage Vdata. Such voltage fluctuation can be reflected to the fifth node N5. The gate-source voltage of the second driving transistor DT2 is set to a value Vdata−Vref+Vth obtained by subtracting the reference voltage Vref from the data voltage Vdata and then adding the threshold voltage Vth to control the second driving current.

A second driving current is supplied from the second driving transistor DT2 to the second light emitting diode ED2 through the eighth switching transistor ST8 which is turned on by the low level of emission signal EM and the second selection transistor TP2 which is turned on by the low level of second selection signal Ps. Therefore, the second light emitting diode ED2 can emit light.

However, as described above, in the second mode, the first scan signal SCAN1 is output only at a high level which is a turn-off level so that in the corresponding frame, the first scan transistor TR1 of the first pixel PX1 can be turned off or maintain a turned-off state. Accordingly, the data voltage Vdata of the corresponding frame is not written in the first node N1 of the first pixel PX1 and each node of the first pixel PX1 can be maintained at a voltage which is initialized in an initialization period P1 of the previous frame. Accordingly, in the second mode, a first driving current is not generated from the first driving transistor DT1 included in the first pixel PX1 so that the first light emitting diode ED1 may not emit light.

Accordingly, when the pixel unit PXU is driven in the second mode, the second driving current is applied only to the second light emitting diode ED2 so that only the second light emitting diode ED2 can emit light.

Further, as described above, in the second mode, the first selection signal Ss for controlling emission of the first light emitting diode ED1 is output only at a high level which is a turn-off level. Therefore, even though an unintended residual current occurs, the first light emitting diode ED1 can maintain a non-emission state in the second mode so that a driving reliability of the pixel unit PXU can be improved.

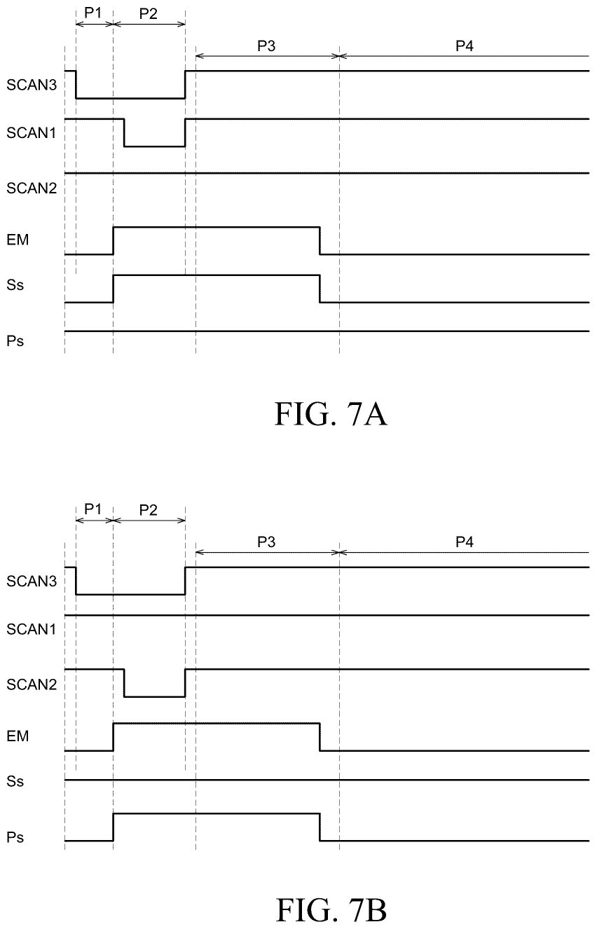

FIGS. 8A and 8B are waveform charts for explaining another example of an operation of the pixel circuit of FIG. 6A and the pixel circuit of FIG. 6B.

In the meantime, in FIG. 8A, a waveform chart for explaining another example that the pixel unit PXU including the first pixel PX1 to which the third pixel circuit PC3 is applied and the second pixel PX2 to which the fourth pixel circuit PC4 is applied is driven in the first mode is illustrated. In FIG. 8B, a waveform chart for explaining another example that the pixel unit PXU including the first pixel PX1 to which the third pixel circuit PC3 is applied and the second pixel PX2 to which the fourth pixel circuit PC4 is applied is driven in the second mode is illustrated.

Referring to FIGS. 6A, 6B, 8A, and 8B, the first selection signal Ss and the second selection signal Ps can have the same signal level. For example, the first selection signal Ss and the second selection signal Ps can have the same signal level, regardless of a driving mode. For example, each of the first selection signal Ss and the second selection signal Ps can have a low level which is a turn-on level in the initialization period P1 and the emission period P4 and have a high level which is a turn-off level in the sampling period P2 and the holding period P3. Even though the first selection signal Ss and the second selection signal Ps have the same signal level, as described above, in the first mode, the second scan signal SCAN2 is output only at a high level which is a turn-off level and in the second mode, the first scan signal SCAN1 is output only at a high level which is a turn-off level. Therefore, in the first mode, the second pixel PX2 to which the fourth pixel circuit PC4 is applied may not emit light and in the second mode, the first pixel PX1 to which the third pixel circuit PC3 is applied may not emit light.

As described above, when it is designed that the first selection signal Ss and the second selection signal Ps have the same signal level regardless of the driving mode, a first selection signal line for applying the first selection signal Ss to the first selection transistor TP1 and a second selection signal line for applying the second selection signal Ps to the second selection transistor TP2 can be designed as the same or substantially same signal line. Therefore, the layout of the pixel unit PXU can be simplified.

FIGS. 9 and 10 are cross-sectional views of a part of a display device according to an example embodiment of the present disclosure.

Particulaly, FIG. 9 illustrates a first pixel PX1 in which a first optical member 161 is disposed and a first light emitting diode ED1 is included, and FIG. 10 illustrates a second pixel PX2 in which a second optical member 162 is disposed and a second light emitting diode ED2 is included.

In the meantime, FIG. 9 illustrates an example of a cross-section of a part of a display device 100 with respect to the first pixel PX1 to which the third pixel circuit PC3 described with reference to FIG. 6A is applied. FIG. 10 illustrates an example of a cross-section of a part of a display device 100 with respect to the second pixel PX2 to which the fourth pixel circuit PC4 described with reference to FIG. 6B is applied.

Referring to FIGS. 9 and 10, the display device 100 according to the example embodiment of the present disclosure can include a substrate 110, a buffer film 111, a gate insulating film 112, an interlayer insulating film 113, a lower protection film 114, an overcoat layer 115, a bank insulating film 116, a first selection transistor TP1, a second selection transistor TP2, a first light emitting diode ED1, a second light emitting diode ED2, a first optical member 161, a second optical member 162, an optical member protection film 170, and an encapsulation member 180.

The substrate 110 can include an insulating material. The substrate 110 can include a transparent material. For example, the substrate 110 can include glass or plastic.

The buffer film 111 can be disposed on the substrate 110. The buffer film 111 can include an insulating material. For example, the buffer film 111 can include an inorganic insulating material, such as silicon oxide (SiOx) or silicon nitride (SiNx). The buffer film 111 can have a multilayered structure. For example, the buffer film 111 can have a laminated structure of a film formed of silicon nitride (SiNx) and a film formed of silicon oxide (SiOx).

The buffer film 111 can be located between the substrate 110 and a driving part of each pixel. The buffer film 111 can suppress the contamination due to the substrate 110 in a process of forming the driving part. For example, a top surface of the substrate 110 facing a driving part of each pixel, for example, the first pixel PX1 and the second PX2, can be covered by the buffer film 111. The driving part of each pixel, for example, the first pixel PX1 and the second pixel PX2 can be located on the buffer film 111.

The gate insulating film 112 can be disposed on the buffer film 111. The gate insulating film 112 can include an insulating material. For example, the gate insulating film 112 can include an inorganic insulating material, such as silicon oxide (SiO) or silicon nitride (SiN). The gate insulating film 112 can include a material having a high permittivity. For example, the gate insulating film 112 can include a High-K material, such as hafnium oxide (HfO). The gate insulating film 112 can have a multilayered structure.

The gate insulating film 112 can extend between the semiconductor layers 121 and 221 of the selection transistors TP1 and TP2 and the gate electrodes 122 and 223. For example, gate electrodes of the driving transistor and the switching transistor can be insulated from semiconductor layers of the driving transistor and the switching transistor by the gate insulating film 112. The gate insulating film 112 can cover the semiconductor layer of each pixel, for example, the first pixel PX1 and the second pixel PX2. The gate electrodes of the driving transistor and the switching transistor can be located on the gate insulating film 112.

The interlayer insulating film 113 can be disposed on the gate insulating film 112. The interlayer insulating film 113 can include an insulating material. For example, the interlayer insulating film 113 can include an inorganic insulating material, such as silicon oxide (SiO) or silicon nitride (SiN). The interlayer insulating film 113 can extend between the gate electrode and the source electrode of each of the driving transistor and the switching transistor and between the gate electrode and the drain electrode. For example, the source electrode and the drain electrode of each of the driving transistor and the switching transistor can be insulated from the gate electrode by the interlayer insulating film 113. The interlayer insulating film 113 can cover the gate electrode of each of the driving transistor and the switching transistor. The source electrode and the drain electrode of each pixel can be located on the interlayer insulating film 113. The gate insulating film 112 and the interlayer insulating film 113 can expose a source region and a drain region of each semiconductor pattern which is located in each pixel.

The lower protection film 114 can be disposed on the interlayer insulating film 113. The lower protection film 114 can include an insulating material. For example, the lower protection film 114 can include an inorganic insulating material, such as silicon oxide (SiO) or silicon nitride (SiN). The lower protection film 114 can suppress the damage of the driving part due to the external moisture and shocks. The lower protection film 114 can extend along surfaces of the driving transistor and the switching transistor which are opposite to the substrate 110. The lower protection film 114 can be in contact with the interlayer insulating film 113 at the outside of the driving part which is located in each pixel, for example, the first pixel PX1 and the second pixel PX2.

The overcoat layer 115 can be disposed on the lower protection film 114. The overcoat layer 115 can include an insulating material. The overcoat layer 115 can include a material different from that of the lower protection film 114. For example, the overcoat layer 115 can include an organic insulating material. The overcoat layer 115 can remove a step caused by the driving part of each pixel. For example, a top surface of the overcoat layer 115 which is opposite to the device substrate 110 can be a flat surface.

The first selection transistor TP1 of the first pixel PX1 and the second selection transistor TP2 of the second pixel PX2 can be disposed on the substrate 110, respectively. The first selection transistor TP1 can be electrically connected between the drain electrode of the first driving transistor DT1 and the first lower electrode 141 of the first light emitting diode ED1. The second selection transistor TP2 can be electrically connected between the drain electrode of the second driving transistor DT2 and the second lower electrode 151 of the second light emitting diode ED2.

The first selection transistor TP1 can include a first semiconductor layer 121, a first gate electrode 122, a first source electrode 123, and a first drain electrode 124. The first selection transistor TP1 can have the same or substantially same structure as the switching transistor and the driving transistor. For example, the first semiconductor layer 121 can be located between the buffer film 111 and the gate insulating film 112 and the first gate electrode 122 can be located between the gate insulating film 112 and the interlayer insulating film 113. The first source electrode 123 and the first drain electrode 124 can be located between the interlayer insulating film 113 and the lower protection film 114. The first gate electrode 122 can overlap a channel region of the first semiconductor layer 121. The first source electrode 123 can be electrically connected to the source region of the first semiconductor layer 121. The first drain electrode 124 can be electrically connected to the drain region of the first semiconductor layer 121.

The second selection transistor TP2 can include a second semiconductor layer 221, a second gate electrode 223, a second source electrode 225, and a second drain electrode 227. For example, the second semiconductor layer 221 can be located on the same layer as the first semiconductor layer 121 and the second gate electrode 223 can be located on the same layer as the first gate electrode 122. The second source electrode 225 and the second drain electrode 227 can be located on the same layer as the first source electrode 123 and the first drain electrode 124. The first light emitting diode ED1 of the first pixel PX1 and the second light emitting diode ED2 of the second pixel PX2 can be disposed on the overcoat layer 115 of the corresponding pixel.

The first light emitting diode ED1 can emit light representing a specific color. For example, the first light emitting diode ED1 can include a first lower electrode 141, a first emission layer 142, and a first upper electrode 143 which are sequentially laminated on the substrate 110.

The first lower electrode 141 can include a conductive material. The first lower electrode 141 can include a material having a high reflectance. For example, the first lower electrode 141 can include metal, such as aluminum (Al), or silver (Ag). The first lower electrode 141 can have a multi-layered structure. For example, the first lower electrode 141 can have a structure in which a reflective electrode formed of a metal is located between transparent electrodes formed of a transparent conductive material, such as ITO and IZO. The first lower electrode 141 can be electrically connected to the first drain electrode 124 of the first selection transistor TP1 through a contact hole which passes through the lower protection film 114 and the overcoat layer 115.

The first emission layer 142 can generate light with luminance corresponding to a voltage difference between the first lower electrode 141 and the first upper electrode 143. For example, the first emission layer 142 can include an emission material layer (EML) including an emission material. The emission material can include an organic material, an inorganic material, or a hybrid material.

The first emission layer 142 can have a multi-layered structure. For example, the first emission layer 142 can further include at least one of a hole injection layer HIL, a hole transport layer HTL, an electron transport layer ETL, and an electron injection layer EIL.

The first upper electrode 143 can include a conductive material. The first upper electrode 143 can include a different material from that of the first lower electrode 141. A transmittance of the first upper electrode 143 can be higher than a transmittance of the first lower electrode 141. For example, the first upper electrode 143 can be a transparent electrode formed of a transparent conductive material, such as ITO and IZO. Accordingly, in the display device 100 according to the example embodiment of the present disclosure, light generated by the first emission layer 142 can be emitted through the first upper electrode 143.

The second light emitting diode ED2 can implement the same or substantially same color as the first light emitting diode ED1. The second light emitting diode ED2 can have the same or substantially same structure as the first light emitting diode ED1. For example, the second light emitting diode ED2 can include a second lower electrode 151, a second emission layer 152, and a second upper electrode 153 which are sequentially laminated on the substrate 110.

The second lower electrode 151 can correspond to the first lower electrode 141, the second emission layer 152 can correspond to the first emission layer 142, and the second upper electrode 153 can correspond to the first upper electrode 143. For example, the second lower electrode 151 can be formed for the second light emitting diode ED2 with the same or substantially same structure as the first lower electrode 141 and this is the same for the second emission layer 152 and the second upper electrode 153. For example, the first light emitting diode ED1 and the second light emitting diode ED2 can be formed to have the same or substantially same structure. However, it is not limited thereto and, in some cases, at least a partial configuration of the first light emitting diode ED1 and the second light emitting diode ED2 can be formed to be different.

The second emission layer 152 can be spaced apart from the first emission layer 142. Therefore, in the display device according to the example embodiment of the present disclosure, light emission by a leakage current can be suppressed.

According to the example embodiment of the present disclosure, in the display device, light can be generated by only one of the first emission layer 142 and the second emission layer 152 by the selection of the user or according to a predetermined condition.

The second lower electrode 151 of the second pixel PX2 included in each pixel unit PXU can be spaced apart from the first lower electrode 141 of the first pixel PX1 included in the corresponding pixel unit PXU. For example, a bank insulating film 116 can be disposed between the first lower electrode 141 and the second lower electrode 151 of each pixel unit PXU. The bank insulating film 116 can include an insulating material. For example, the bank insulating film 116 can include an organic insulating material. The bank insulating film 116 can include a material different from that of the overcoat layer 115.

The second lower electrode 151 of the second pixel PX2 included in each pixel unit PXU can be insulated from the first lower electrode 141 of the first pixel PX1 included in the corresponding pixel unit PXU, by the bank insulating film 116. For example, the bank insulating film 116 can cover an edge of the first lower electrode 141 located in the first pixel PX1 included in each pixel unit PXU and an edge of the second lower electrode 151 located in the second pixel PX2 included in the corresponding pixel unit PXU. Accordingly, in the display device 100, an image by a first optical area of each pixel unit PXU in which the first light emitting diode ED1 is located and an image by a second optical area of the corresponding pixel unit PXU in which the second light emitting diode ED2 is located can be provided to the user.

The first emission layer 142 and the first upper electrode 143 of the first light emitting diode ED1 located in the first pixel PX1 can be laminated on a partial area of the first lower electrode 141 exposed by the bank insulating film 116. The second emission layer 152 and the second upper electrode 153 of the second light emitting diode ED2 located in the second pixel PX2 can be laminated on a partial area of the second lower electrode 151 exposed by the bank insulating film 116. For example, the bank insulating film 116 can divide a first emission area in which light by the first light emitting diode ED1 is emitted in the first pixel PX1 and a second emission area in which light by the second light emitting diode ED2 is emitted in the second pixel PX2. A size of the second emission area which is divided in the pixel unit PXU can be smaller than a size of the first emission area.

The second upper electrode 153 of the second pixel PX2 can be electrically connected to the first upper electrode 143 of the first pixel PX1. For example, a voltage applied to the second upper electrode 153 of the second light emitting diode ED2 located in the second pixel PX2 can be equal to a voltage applied to the first upper electrode 143 of the first light emitting diode ED1 located in the first pixel PX1. The second upper electrode 153 of the second pixel PX2 can include the same or substantially same material as the first upper electrode 143 of the first pixel PX1. For example, the second upper electrode 153 of the second pixel PX2 can be formed simultaneously with the first upper electrode 143 of the first pixel PX1. The second upper electrode 153 of the second pixel PX2 extends onto the bank insulating film 116 to be in direct contact with the first upper electrode 143 of the first pixel PX1 included in the pixel unit PXU. A luminance of a first optical area located in each pixel unit PXU and a luminance of a second optical area can be controlled by a driving current generated in the corresponding pixel unit PXU.

The encapsulation member 180 can be located on the first light emitting diode ED1 and the second light emitting diode ED2 of each pixel unit PXU. The encapsulation member 180 can suppress the damage of the first light emitting diode ED1 and the second light emitting diode ED2 due to moisture and shocks from the outside. The encapsulation member 180 can have a multi-layered structure. For example, the encapsulation member 180 can include a first encapsulation layer 181, a second encapsulation layer 182, and a third encapsulation layer 183 which are sequentially laminated, but it is not limited thereto. The first encapsulation layer 181, the second encapsulation layer 182, and the third encapsulation layer 183 can include an insulating material. The second encapsulation layer 182 can include a material different from those of the first encapsulation layer 181 and the third encapsulation layer 183. For example, the first encapsulation layer 181 and the third encapsulation layer 183 can be inorganic encapsulation layers including an inorganic insulating material and the second encapsulation layer 182 can include an organic encapsulation layer including an organic insulating material. Therefore, the first light emitting diode ED1 and the second light emitting diode ED2 of the display device 100 can efficiently suppress the damage due to the moisture and shocks from the outside.

The first optical member 161 and the second optical member 162 can be disposed on the encapsulation member 180.

The first optical member 161 can be disposed on the first light emitting diode ED1. Light which is generated by the first light emitting diode ED1 of the first pixel PX1 can be emitted by the first optical member 161 which is disposed in the first optical area of the corresponding pixel unit PXU. The first optical member 161 can have a shape that does not limit light of at least one direction. For example, a planar shape of the first optical member 161 can have a bar shape extending in one direction.

In this case, a traveling direction of the corresponding light emitted from the first optical area which is located in the first pixel PX1 of each pixel unit PXU may not be limited to one direction. For example, contents (or images) provided through the first optical area located in the first pixel PX1 of each pixel unit PXU can be shared by surrounding people which are adjacent to the user in one direction. Accordingly, the contents provided by the light emitted through the first optical member 161 can be provided in a first viewing angle range which is larger than a viewing angle of the contents provided by the light emitted through the second optical member 162. For example, the content provided by the light emitted through the first optical member 161 can be provided in a wide field-of-view mode (share mode).

The second optical member 162 can be disposed on the second light emitting diode ED2. Light which is generated by the second light emitting diode ED2 of the second pixel PX2 can be emitted by the second optical member 162 which is disposed in the second optical area of the corresponding pixel unit PXU. The second optical member 162 can restrict a traveling direction of passing light in one direction and/or the other direction. For example, a planar shape of the second optical member 162 located in the second pixel PX2 of each pixel unit PXU can have a circular shape.

In this case, a traveling direction of light emitted from the second optical area which is located in the second pixel PX2 of each pixel unit PXU can be restricted to one direction and/or the other direction. For example, contents (or images) provided through the second optical area located in the second pixel PX2 of each pixel unit PXU may not be shared by surrounding people of the user. Accordingly, the contents provided by the light emitted through the second optical member 162 can be provided in a second viewing angle range which is smaller than a viewing angle of the contents provided by the light emitted through the first optical member 161. For example, the content provided by the light emitted through the second optical member 162 can be provided in a narrow field-of-view mode (private mode).

The first emission area located in the first pixel PX1 of each pixel unit PXU can have a shape corresponding to the first optical member 161 located in the corresponding pixel unit PXU. For example, a planar shape of the first emission area of each pixel unit PXU can have a bar shape which extends in one direction. The first optical member 161 can have a size larger than the first emission area of the corresponding pixel unit PXU. Accordingly, the efficiency of light emitted from the first emission area of the first pixel PX1 can be improved.

The second emission area located in the second pixel PX2 of each pixel unit PXU can have a shape corresponding to the second optical member 162 located in the corresponding pixel unit PXU. For example, a planar shape of the second emission area of each pixel unit PXU can have a circular shape. The second optical member 162 can have a size larger than the second emission area located in the second pixel PX2 of the corresponding pixel unit PXU. Accordingly, the efficiency of light emitted from the second emission area of the second pixel PX2 can be improved.

The optical member protection film 170 can be located on the first optical member 161 of the first pixel PX1 and the second optical member 162 of the second pixel PX2 included in the pixel unit PXU. The optical member protection film 170 can include an insulating material. For example, the optical member protection film 170 can include an organic insulating material. A refractive index of the optical member protection film 170 can be smaller than a refractive index of the first optical member 161 and a refractive index of the second optical member 162. Accordingly, in the display device 100 according to the example embodiment of the present disclosure, light which passes through the first optical member 161 and the second optical member 162 in each pixel unit PXU may not be reflected toward the substrate 110 due to the refractive index difference from the optical member protection film 170.

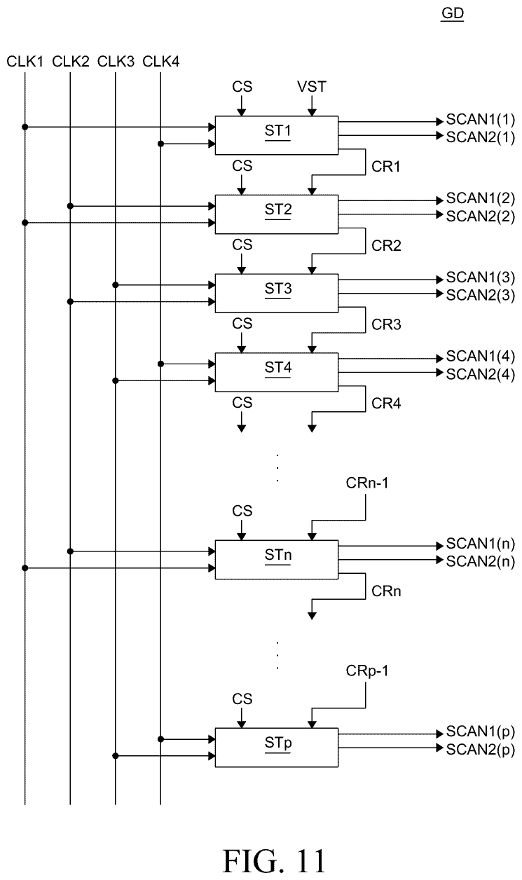

FIG. 11 is a block diagram illustrating a gate driving circuit according to an example embodiment of the present disclosure.

Referring to FIG. 11, a gate driving circuit GD can include a plurality of stages ST1, ST2, ST3, ST4, . . . , STn, . . . , STp (here, p is an integer larger than 1, and n is an integer which is equal to or larger than 1 and equal to or smaller than p). In the meantime, in FIG. 11, only a part of a gate driving circuit GD is illustrated for the convenience of description.

Each of the plurality of stages ST1, ST2, ST3, ST4, . . . , STn, . . . , STp can be connected to a corresponding clock line, among a first clock line configured to supply a first clock signal CLK1, a second clock line configured to supply a second clock signal CLK2, a third clock line configured to supply a third clock signal CLK3, and a fourth clock line configured to supply a fourth clock signal CLK4. For example, each of the plurality of stages ST1, ST2, ST3, ST4, . . . , STn, . . . , STp can be connected to two clock lines among the first to fourth clock lines.

Specifically, when an m-th stage, among the plurality of stages ST1, ST2, ST3, ST4, . . . , STn, . . . , STp, is connected to a first clock line configured to supply the first clock signal CLK1 and a fourth clock line configured to supply the fourth clock signal CLK4, an m+1-th stage can be connected to a second clock line configured to supply the second clock signal CLK2 and the first clock line configured to supply the first clock signal CLK1. Further, an m+2-th stage can be connected to a third clock line configured to supply the third clock signal CLK3 and the second clock line configured to supply the second clock signal CLK2 and an m+3-th stage can be connected to the fourth clock line configured to supply the fourth clock signal CLK4 and the third clock line configured to supply the third clock signal CLK3. In this case, m+3 is a natural number which is equal to or smaller than p. For example, as illustrated in FIG. 11, the first stage ST1 can be connected to the first clock line and the fourth clock line and the second stage ST2 can be connected to the second clock line and the first clock line. Further, the third stage ST3 can be connected to the third clock line and the second clock line and the fourth stage ST4 can be connected to the fourth clock line and the third clock line. Further, the n-th stage STn can be connected to the second clock line configured to supply the second clock signal CLK2 and the first clock line configured to supply the first clock signal CLK1 and the p-th stage STp can be connected to the fourth clock line configured to supply the fourth clock signal CLK4 and the third clock line configured to supply the third clock signal CLK3. As described above, in the unit of four adjacent stages, two clock lines can be connected to the corresponding stage, respectively.

A control signal CS and an input signal can be supplied to each of the plurality of stages ST1, ST2, ST3, ST4, . . . , STn, . . . , STp. Here, the input signal can be any one of a start signal VST or a previous carry signal. For example, the start signal VST can be supplied to the first stage ST1, among the plurality of stages ST1, ST2, ST3, ST4, . . . , STn, . . . , STp, and the previous carry signal can be supplied to the remaining stages ST2, ST3, ST4, . . . , STn, . . . , STp. For example, a first carry signal CR1 output from the first stage ST1 can be supplied to the second stage ST2, a second carry signal CR2 output from the second stage ST2 can be supplied to the third stage ST3, and a third carry signal CR3 output from the third stage ST3 can be supplied to the fourth stage ST4. A fourth carry signal CR4 output from the fourth stage ST4 can be supplied to the fifth stage, an n−1-th carry signal CRn−1 output from an n−1-th stage can be supplied to the n-th stage STn, an n-th carry signal CRn output from the n-th stage STn can be supplied to a n+1-th stage, and a p−1-th carry signal CRp−1 output from a p−1-th stage can be supplied to the p-th stage STp.

Each of the plurality of stages ST1, ST2, ST3, ST4, . . . , STn, . . . , STp can output carry signals CR1 to CRp−1, first scan signals SCAN1(1) to SCAN1(p), and second scan signals SCAN2(1) to SCAN2(p).

For example, the first stage ST1 can generate a first selection scan signal having a low level of pulse which is a turn-on level, corresponding to a scan signal to be supplied to the pixel unit PXU disposed in the first pixel row of the active area AA, based on the first clock signal CLK1 and the start signal VST. Further, the first stage ST1 can output a generated first selection scan signal, for example, a first selection scan signal having a low level pulse which is a turn-on level as any one of a first first scan signal SCAN1(1) and a first second scan signal SCAN2(1) to be supplied to the pixel unit PXU disposed in the first pixel row, based on the second clock signal CLK2 and the control signal CS. Further, the first stage can output the other one as a turn-off level. For example, the first stage ST1 can output any one of the first first scan signal SCAN1(1) and the first second scan signal SCAN2(1) to be supplied to the pixel unit PXU disposed in the first pixel row, as a scan signal having a turn-on level pulse and output the other one as a scan signal which is maintained at a turn-off level, based on the start signal VST, the first clock signal CLK1, the fourth clock signal CLK4, and the control signal CS.

Further, the second stage ST2 can generate a second selection scan signal having a low level of pulse which is a turn-on level corresponding to a scan signal to be supplied to the pixel unit PXU disposed in the second pixel row of the active area AA, based on the second clock signal CLK2 and the first carry signal CR1. Further, the second stage ST2 can output a generated second selection scan signal, for example, a second selection scan signal having a low level of pulse which is a turn-on level as any one of a second first scan signal SCAN1(2) and a second second scan signal SCAN2(2) to be supplied to the pixel unit PXU disposed in the second pixel row, based on the third clock signal CLK3 and the control signal CS. Further, the second stage can output the other one as a turn-off level. For example, the second stage ST2 can output any one of a second first scan signal SCAN1(2) and a second second scan signal SCAN2(2) to be supplied to the pixel unit PXU disposed in the second pixel row, based on the first carry signal CR1, the second clock signal CLK2, the first clock signal CLK1, and the control signal CS, as a scan signal having a turn-on level of pulse. Further, the second stage ST2 can output the other one as a scan signal which is maintained at a turn-off level. Similarly to this, the remaining stages ST3, ST4, . . . , STn, . . . , STp can output any one of the first scan signal SCAN1 and the second scan signal SCAN2 to be supplied to the pixel unit PXU disposed in the corresponding pixel row as a scan signal having a turn-on level of pulse and output the other one as a scan signal which is maintained at a turn-off level.

As described above, the gate driving circuit GD according to example embodiments of the present disclosure can output the first scan signal SCAN1 having a turn-on level of pulse and output the second scan signal SCAN2 which is maintained at a turn-off level in each pixel row. Alternatively, the gate driving circuit GD can output the second scan signal SCAN2 having a turn-on level of pulse and output the first scan signal SCAN1 which is maintained at a turn-off level. Accordingly, when the first scan signal SCAN1 having a turn-on level of pulse and the second scan signal SCAN2 which is maintained at a turn-off level are supplied to the corresponding pixel row, the first pixel PX1 included in each of the plurality of pixel units PXU disposed in the corresponding pixel row emits light and the second pixel PX2 does not emit light. Therefore, the plurality of pixel units PXU disposed in the corresponding pixel row can operate in a first mode which is a wide field-of-view mode. In contrast, when the second scan signal SCAN2 having a turn-on level of pulse and the first scan signal SCAN1 which is maintained at a turn-off level are supplied to the corresponding pixel row, the first pixel PX1 included in each of the plurality of pixel units PXU disposed in the corresponding pixel row does not emit light and the second pixel PX2 emits light. Therefore, the plurality of pixel units PXU disposed in the corresponding pixel row can operate in a second mode which is a narrow field-of-view mode.

As described above, the gate driving circuit GD according to example embodiments of the present disclosure independently supplies the first scan signal SCAN1 and the second scan signal SCAN2 in a pixel row unit to control a driving mode of the first pixel PX1 and the second pixel PX2 included in each of the plurality of pixel units PXU disposed in the corresponding pixel row. Therefore, the driving mode of each area can be independently controlled in each area of the active area AA, specifically, in a pixel row unit.

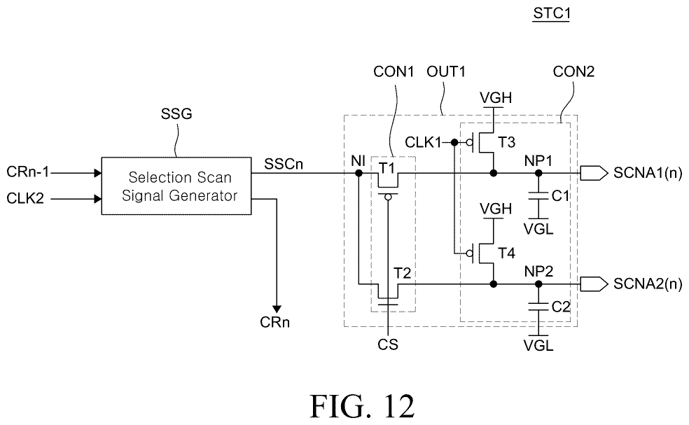

FIG. 12 is a circuit diagram illustrating an example of a stage circuit included in a gate driving circuit of FIG. 11.

In the meantime, a first stage circuit STC1 illustrated in FIG. 12 represents an example of a stage circuit corresponding to a stage connected to a first clock line and a second clock line, among a plurality of stages ST1, ST2, ST3, ST4, . . . , STn, . . . , STp included in the gate driving circuit GD which has been described with reference to FIG. 11, for example, an n-th stage STn. Therefore, hereinafter, a connection relationship and driving of the plurality of stages ST1, ST2, ST3, ST4, . . . , STn, . . . , STp included in the gate driving circuit GD will be described with reference to the n-th stage STn.

Referring to FIGS. 11 and 12, at least some of the plurality of transistors included in the first stage circuit STC1 can be an n-type transistor or a p-type transistor. For example, the first transistor T1, the third transistor T3, and the fourth transistor included in the first stage circuit STC1 can be p-type transistors and the second transistor T2 can be an n-type transistor. Accordingly, when a low level of signal is applied to gate electrodes, the first transistor T1, the third transistor T3, and the fourth transistor can be turned on and when a high level of signal is applied to a gate electrode, the second transistor T2 can be turned on.

The first stage circuit STC1 can include a selection scan signal generating unit SSG and a first output unit OUT1. The selection scan signal generating unit SSG generates an n-th selection scan signal (hereinafter, referred to as a “selection scan signal SSCn”) having a pulse corresponding to a scan signal to be supplied to an n-th pixel row and an n-th carry signal (hereinafter, referred to as a “carry signal CRn”) based on an input signal which is any one of the start signal VST and the previous carry signal and the second clock signal CLK2. The first output unit OUT1 outputs an n-th first scan signal (hereinafter, referred to as a “first scan signal SCAN1(n)”) and an n-th second scan signal (hereinafter, referred to as a “second scan signal SCAN2(n)”) to be supplied to the n-th pixel row, based on the selection scan signal SSn, the control signal CS, the first clock signal CLK1, a first voltage VGH, and a second voltage VGL.

In the meantime, the first voltage VGH can be higher than the second voltage VGL. For example, the first voltage VGH can be a positive voltage and the second voltage VGL can be a negative voltage.

The selection scan signal generating unit SSG can generate the selection scan signal SSn and the carry signal CRn based on a previous carry signal, for example, an n−1-th carry signal (hereinafter, referred to as a “previous carry signal CRn−1”) and the second clock signal CLK2, as input signals. For example, each of the plurality of stages ST1, ST2, ST3, ST4, . . . , STn, . . . , STp of the gate driving circuit GD can generate a selection scan signal SSn in the form of a shift register. In the meantime, the carry signal CRn can be provided as an input signal of a next stage.

The first output unit OUT1 can output the first scan signal SCAN1(n) and the second scan signal SCAN2(n) based on the selection scan signal SSn supplied from the selection scan signal generating unit SSG, the first clock signal CLK1, the control signal CS, the first voltage VGH, and the second voltage VGL.

To this end, the first output unit OUT1 can include a first controller CON1 and a second controller CON2. The first controller CON1 supplies the selection scan signal SSCn to any one of a first output node NP1 and a second output node NP2, based on the selection scan signal SSCn and the control signal CS. The second controller CON2 controls a voltage of the first output node NP1 and a voltage of the second output node NP2, based on the first clock signal CLK1, the first voltage VGH, and the second voltage VGL, outputs a voltage of the first output node NP1 as a first scan signal SCAN1(n), and outputs a voltage of the second output node NP2 as a second scan signal SCAN2(n).

The first controller CON1 can include a first transistor T1 and a second transistor T2.

The first transistor T1 can be connected between an input node N1 to which the selection scan signal SSCn is supplied and the first output node NP1 and a gate electrode of the first transistor T1 can be connected to a control signal line to which the control signal CS is supplied. The first transistor T1 can be turned on or turned off by the control signal CS. For example, when a low level of control signal CS which is a turn-on level is supplied, the first transistor T1 can electrically connect the input node N1 and the first output node NP1. In this case, a voltage of the input node N1, for example, the selection scan signal SSCn can be supplied to the first output node NP1.

The second transistor T2 can be connected between the input node N1 to which the selection scan signal SSCn is supplied and the second output node NP2 and a gate electrode of the second transistor T2 can be connected to the control signal line to which the control signal CS is supplied. The second transistor T2 can be turned on or turned off by the control signal CS. For example, when a low level of control signal CS which is a turn-on level is supplied, the second transistor T2 can electrically connect the input node N1 and the second output node NP2. In this case, a voltage of the input node N1, for example, the selection scan signal SSCn can be supplied to the second output node NP2.

According to a signal level of the control signal CS supplied to the control signal line, any one of the first transistor T1 and the second transistor T2 can be turned on and the other transistor can be turned off. For example, when a low level of control signal CS is supplied, only the first transistor T1 is turned on so that the selection scan signal SSCn is supplied to the first output node NP1, but the selection scan signal SSCn is not supplied to the second output node NP2. When a high level of control signal CS is supplied, only the second transistor T2 is turned on so that the selection scan signal SSCn is supplied to the second output node NP2, but the selection scan signal SSCn is not supplied to the first output node NP1.

As described above, the first controller CON1 can supply the selection scan signal SSCn to any one of the first output node NP1 and the second output node NP2.

The second controller CON2 can include a third transistor T3, a fourth transistor T4, a first capacitor C1, and a second capacitor C2.

The third transistor T3 can be connected between the first voltage line to which the first voltage VGH is supplied and the first output node NP1 and a gate electrode of the third transistor T3 can be connected to the first clock line to which the first clock signal CLK1 is supplied. The third transistor T3 can be turned on or turned off by the first clock signal CLK1. For example, the third transistor T3 can be turned on when the low level of first clock signal CLK1 which is a turn-on level is supplied to supply the first voltage VGH to the first output node NP1.

The fourth transistor T4 can be connected between the first voltage line to which the first voltage VGH is supplied and the second output node NP2 and a gate electrode of the fourth transistor T4 can be connected to the first clock line to which the first clock signal CLK1 is supplied. The fourth transistor T4 can be turned on or turned off by the first clock signal CLK1. For example, the fourth transistor T4 can be turned on when the low level of first clock signal CLK1 which is a turn-on level is supplied to supply the first voltage VGH to the second output node NP2.

The first capacitor C1 can be connected between the first output node NP1 and the second voltage line to which the second voltage VGL is supplied. For example, the first capacitor C1 can include a first electrode connected to the first output node NP1 and a second electrode connected to the second voltage line. The first capacitor C1 can store a voltage of the first output node NP1. Here, the second electrode of the first capacitor C1 is connected to the second voltage line to which a second voltage VGL which is a constant voltage is supplied so that the voltage of the first output node NP1 can be stably maintained.

The second capacitor C2 can be connected between the second output node NP2 and the second voltage line to which the second voltage VGL is supplied. For example, the second capacitor C2 can include a first electrode connected to the second output node NP2 and a second electrode connected to the second voltage line. The second capacitor C2 can store a voltage of the second output node NP2. Here, the second electrode of the second capacitor C2 is connected to the second voltage line to which a second voltage VGL which is a constant voltage is supplied so that the voltage of the second output node NP2 can be stably maintained.

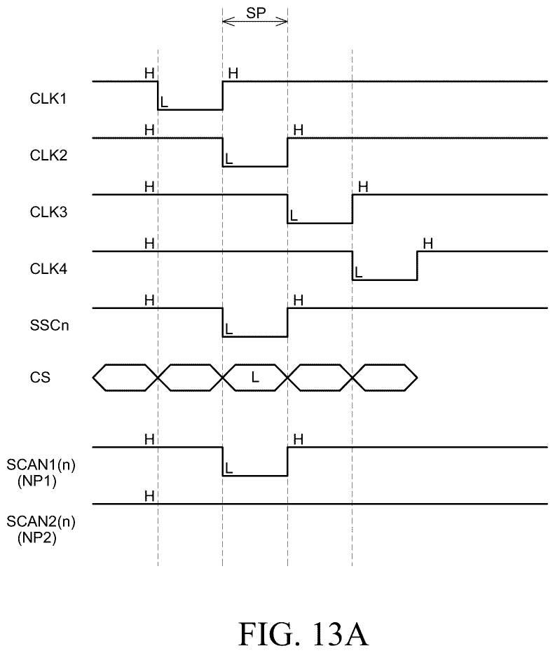

FIGS. 13A and 13B are waveform charts for explaining an example of an operation of a stage circuit of FIG. 12.

In the meantime, FIG. 13A illustrates a waveform chart for explaining an example that a pixel unit PXU to which a first scan signal SCAN1(n) and a second scan signal SCAN2(n) output by the first stage circuit STC1 described with reference to FIG. 12 are supplied is driven in a first mode. FIG. 13B illustrates a waveform chart for explaining an example that a pixel unit PXU to which a first scan signal SCAN1(n) and a second scan signal SCAN2(n) output by the first stage circuit STC1 described with reference to FIG. 12 are supplied is driven in a second mode.

In the meantime, a scanning period SP illustrated in FIGS. 13A and 13B can correspond to a period in which a plurality of pixel units PXU disposed in a pixel row to which a first scan signal SCAN1(n) and the second scan signal SCAN2(n) output by the first stage circuit STC1 are provided during one frame period, for example, the n-th pixel row, scans, for example, turns on, the first scan transistor TR1 or the second scan transistor TR2 of the first pixel PX1 by the first scan signal SCAN1(n) or the second scan signal SCAN2(n) to apply the data voltage Vdata to the first pixel PX1 or the second pixel PX2. Therefore, in the present disclosure, the scanning period SP can be substantially the same as a sampling period P2 in which a low level of first scan signal SCAN1 which is a turn-on level or a low level of second scan signal SCAN2 which is a turn-on level described with reference to FIGS. 5A, 5B, 7A, and 7B is supplied.

Further, referring to FIGS. 13A and 13B, the first clock signal CLK1 supplied through the first clock line, the second clock signal CLK2 supplied through the second clock line, the third clock signal CLK3 supplied through the third clock line, and the fourth clock signal CLK4 supplied through the fourth clock line can have the same cycle. Each of the first clock signal CLK1, the second clock signal CLK2, the third clock signal CLK3, and the fourth clock signal CLK4 can have a low level L during a period corresponding to a quarter cycle and have a high level H during a remaining period. For example, each of the first clock signal CLK1, the second clock signal CLK2, the third clock signal CLK3, and the fourth clock signal CLK4 can have a low level L of pulse corresponding to a quarter cycle in one cycle.

The first clock signal CLK1, the second clock signal CLK2, the third clock signal CLK3, and the fourth clock signal CLK4 can have a predetermined phase difference. For example, the second clock signal CLK2 can be delayed by a phase difference of a quarter cycle from the first clock signal CLK1. The third clock signal CLK3 can be delayed by a phase difference of a quarter cycle from the second clock signal CLK2. The fourth clock signal CLK4 can be delayed by a phase difference of a quarter cycle from the third clock signal CLK3. Accordingly, a period in which the first clock signal CLK1 has a low level L of pulse, a period in which the second clock signal CLK2 has a low level L of pulse, a period in which the third clock signal CLK3 has a low level L of pulse, and a period in which the fourth clock signal CLK4 has a low level L of pulse may not overlap.

First, a mode in which the corresponding pixel unit PXU is driven in a first mode which is a wide field-of-view mode will be described with reference to FIGS. 12 and 13A. The third transistor T3 and the fourth transistor T4 can be turned on by the first clock signal CLK1 which has a low level L in a period prior to the scanning period SP. Therefore, a high level H of first voltage VGH is supplied to the first output node NP1 and the second output node NP2 so that a voltage of the first output node NP1 and a voltage of the second output node NP2 can have a high level H in a period prior to the scanning period SP, for example, in a previous period.

In the scanning period SP, the selection scan signal generating unit SSG can generate a selection scan signal SSCn having a low level L based on a previous carry signal CRn−1 and a low level L of second clock signal CLK2.

Further, in the corresponding scanning period SP, the control signal CS has a low level L so that the first transistor T1 can be turned on and the second transistor T2 can be turned off.

Accordingly, the selection scan signal SSCn having a low level L can be supplied to the first output node NP1 by the turned-on first transistor T1. Accordingly, in the corresponding scanning period SP, the voltage of the first output node NP1 can have a low level L. Therefore, in the corresponding scanning period SP, the first scan signal SCAN1(n) can be output as a low level L which is a voltage of the first output node NP1.

In the meantime, in the corresponding scanning period SP, the second transistor T2 is turned off or maintains a turned-off state so that the voltage of the second output node NP2 can be maintained at a high level H which is a voltage prior to the corresponding scanning period SP. Therefore, in the corresponding scanning period SP, the second scan signal SCAN2(n) can be output as a high level H which is a voltage of the second output node NP2.

Next, a mode in which the corresponding pixel unit PXU is driven in a second mode which is a narrow field-of-view mode will be described with reference to FIGS. 12 and 13B. The third transistor T3 and the fourth transistor T4 can be turned on by the first clock signal CLK1 which has a low level L in a period prior to the scanning period SP. Therefore, a high level H of first voltage VGH is supplied to the first output node NP1 and the second output node NP2 so that each of a voltage of the first output node NP1 and a voltage of the second output node NP2 can have a high level H in a period prior to the scanning period, for example, in a previous period.

In the scanning period SP, the selection scan signal generating unit SSG can generate a selection scan signal SSCn having a low level L based on a previous carry signal CRn−1 and a low level L of second clock signal CLK2.

Further, in the corresponding scanning period SP, the control signal CS has a high level H so that the second transistor T2 can be turned on and the first transistor T1 can be turned off.

Accordingly, the selection scan signal SSCn having a low level L can be supplied to the second output node NP2 by the turned-on second transistor T2. Accordingly, in the corresponding scanning period SP, the voltage of the second output node NP2 can have a low level L. Therefore, in the corresponding scanning period SP, the second scan signal SCAN2(n) can be output as a low level L which is a voltage of the second output node NP2.

In the meantime, in the corresponding scanning period SP, the first transistor T1 is turned off or maintains a turned-off state so that the voltage of the first output node NP1 can be maintained at a high level H which is a voltage prior to the corresponding scanning period SP. Therefore, in the corresponding scanning period SP, the first scan signal SCAN1(n) can be output as a high level H which is a voltage of the first output node NP1.

As described above, according to a signal level of the control signal CS in the scanning period SP in a corresponding pixel row, the first transistor T1 is turned on to output a low level L of first scan signal SCAN1(n) or the second transistor T2 is turned on to output a low level L of second scan signal SCAN2(n).

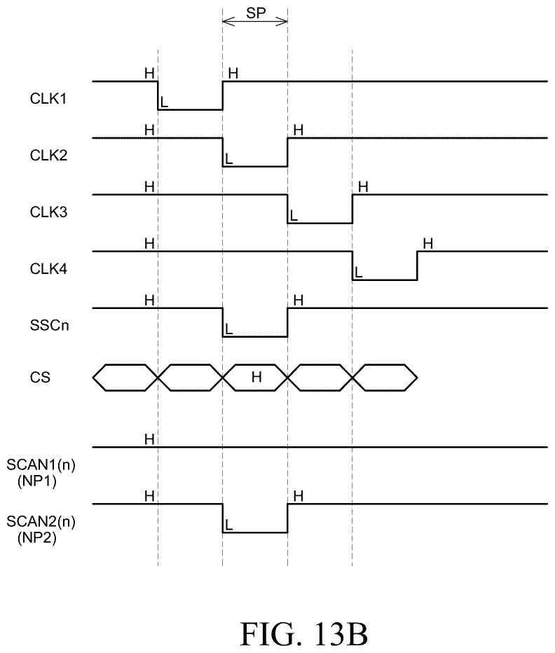

FIG. 14 is a waveform chart for explaining an example of an operation of a gate driving circuit.

In the meantime, FIG. 14 illustrates a waveform chart of signals in a first scanning period SP1, a second scanning period SP2, a third scanning period SP3, and a fourth scanning period SP4. In the first scanning period SP1, a plurality of pixel units PXU disposed in a first pixel row to which a first scan signal SCAN1(1) and a second scan signal SCAN2(1) output by a first stage ST1, among a plurality of stages ST1, ST2, ST3, ST4, . . . , STn, . . . , STp included in a gate driving circuit GD, are supplied in one frame period, is scanned. In the second scanning period SP2, a plurality of pixel units PXU disposed in a second pixel row to which a first scan signal SCAN1(2) and a second scan signal SCAN2(2) output by a second stage ST2 are supplied is scanned. In the third scanning period SP3, a plurality of pixel units PXU disposed in a third pixel row to which a first scan signal SCAN1(3) and a second scan signal SCAN2(3) output by a third stage ST3 are supplied is scanned. In the fourth scanning period SP4, a plurality of pixel units PXU disposed in a fourth pixel row to which a first scan signal SCAN1(4) and a second scan signal SCAN2(4) output by a fourth stage ST4 are supplied is scanned.

Referring to FIGS. 11, 12, and 14, in the first scanning period SP1, the second scanning period SP2, the third scanning period SP3, and the fourth scanning period SP4, a low level L of first selection scan signal SSC1, a low level L of second selection scan signal SSC2, a low level L of third selection scan signal SSC3, and a low level L of fourth selection scan signal SSC4 are sequentially generated. For example, a selection scan signal generating unit SSG of the first stage ST1 can generate a low level L of first selection scan signal SSC1 in the first scanning period SP1. A selection scan signal generating unit SSG of the second stage ST2 can generate a low level L of second selection scan signal SSC2 in the second scanning period SP2. A selection scan signal generating unit SSG of the third stage ST3 can generate a low level L of third selection scan signal SSC3 in the third scanning period SP3. A selection scan signal generating unit SSG of the fourth stage ST4 can generate a low level L of fourth selection scan signal SSC4 in the fourth scanning period SP4.

The control signal CS can have a low level L in the first scanning period SP1 and the fourth scanning period SP4.

Accordingly, in the first scanning period SP1, the low level L of first selection scan signal SSC1 can be supplied to the first output node NP1 of the first stage ST1 and in the fourth scanning period SP4, the low level L of fourth selection scan signal SSC4 can be supplied to the first output node NP1 of the fourth stage ST4.

Accordingly, the first first scan signal SCAN1(1) and the fourth first scan signal SCAN1(4) supplied to the first pixel row and the fourth pixel row, respectively, can have a low level L in the corresponding scanning period. For example, in the first scanning period SP1, the low level L of first scan signal SCAN1(1) can be supplied to the first pixel row and in the fourth scanning period SP4, the low level of first scan signal SCAN1(4) can be supplied to the fourth pixel row.

In the meantime, the control signal CS has a low level L in the first scanning period SP1 and the fourth scanning period SP4 so that the first second scan signal SCAN2(1) and the fourth second scan signal SCAN2(4) supplied to the first pixel row and the fourth pixel row, respectively, can be output at a high level H.

Further, the control signal CS can have a high level H in the second scanning period SP2 and the third scanning period SP3.

Accordingly, in the second scanning period SP2, the low level L of second selection scan signal SSC2 can be supplied to the second output node NP2 of the second stage ST2 and in the third scanning period SP3, the low level L of third selection scan signal SSC3 can be supplied to the second output node NP2 of the third stage ST3.

The second second scan signal SCAN2(2) and the third second scan signal SCAN2(3) supplied to the second pixel row and the third pixel row, respectively, can have a low level L in the corresponding scanning period. For example, in the second scanning period SP2, the low level L of second scan signal SCAN2(2) can be supplied to the second pixel row and in the third scanning period SP3, the low level of second scan signal SCAN2(3) can be supplied to the third pixel row.

In the meantime, the control signal CS has a high level H in the second scanning period SP2 and the third scanning period SP3 so that the second first scan signal SCAN1(2) and the third first scan signal SCAN1(3) supplied to the second pixel row and the third pixel row, respectively, can be output at a high level H.

As described above, the gate driving circuit GD according to the example embodiments of the present disclosure and the display device 100 including the same control a signal level of a control signal CS in the scanning period SP in a corresponding pixel row in each pixel row to control the driving mode in each pixel row.

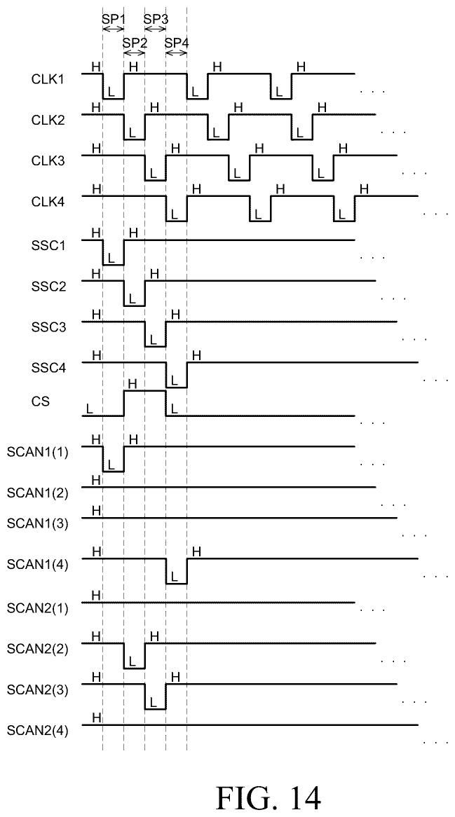

FIG. 15 is a circuit diagram illustrating another example of a stage circuit included in the gate driving circuit of FIG. 11.

In the meantime, the second stage circuit STC2 illustrated in FIG. 15 represents another example of a stage circuit corresponding to a stage connected to a first clock line and a second clock line, among a plurality of stages ST1, ST2, ST3, ST4, . . . , STn, . . . , STp included in a gate driving circuit GD which has been described with reference to FIG. 11, for example, an n-th stage STn. For example, FIG. 15 illustrates a modified example of an example embodiment of FIG. 12, with regard to a transistor type of a first transistor T1 and a second transistor T2 so that a redundant description will not be repeated.

Referring to FIG. 15, a second stage circuit STC2 can include a selection scan signal generating unit SSG and a second output unit OUT2.

At least some of a plurality of transistors included in a second output unit OUT2 of a second stage circuit STC2 can be an n-type transistor or a p-type transistor. For example, the second transistor T2, the third transistor T3, and the fourth transistor included in a second output unit OUT2 in the second stage circuit STC2 can be p-type transistors and the first transistor T1 can be an n-type transistor.

Accordingly, when a low level of signal is applied to gate electrodes, the second transistor T2, the third transistor T3, and the fourth transistor can be turned on and when a high level of signal is applied to a gate electrode, the first transistor T1 can be turned on.

For example, when the high level of control signal CS is supplied, only the first transistor T1 is turned on to supply a low level of selection scan signal SSCn to the first output node NP1. When the low level of control signal CS is supplied, only the second transistor T2 is turned on to supply a low level of selection scan signal SSCn to the second output node NP2.

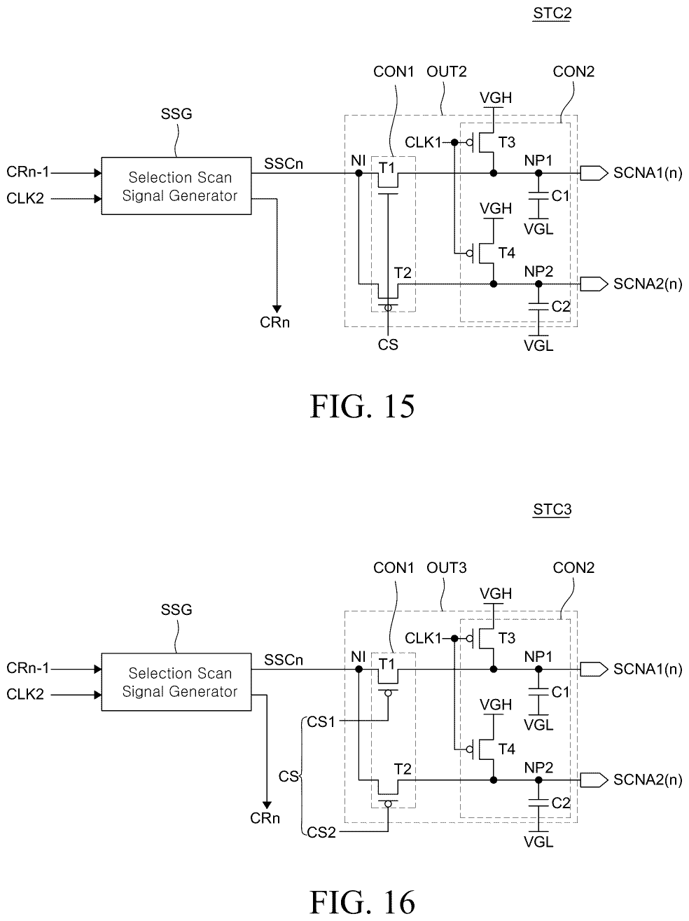

FIG. 16 is a circuit diagram illustrating still another example of a stage circuit included in the gate driving circuit of FIG. 11.

In the meantime, the third stage circuit STC3 illustrated in FIG. 16 represents still another example of a stage circuit corresponding to a stage connected to a first clock line and a second clock line, among a plurality of stages ST1, ST2, ST3, ST4, . . . , STn, . . . , STp included in a gate driving circuit GD which has been described with reference to FIG. 11, for example, an n-th stage STn. For example, FIG. 16 illustrates a modified example of an example embodiment of FIG. 12, with regard to a transistor type of a second transistor T2 and a control signal CS so that a redundant description will not be repeated.

Referring to FIG. 16, all a plurality of transistors included in the third stage circuit STC3 can be p-type transistors. For example, the first transistor T1, the second transistor T2, the third transistor T3, and the fourth transistor included in the third stage circuit STC3 can be p-type transistors. Accordingly, when a low level of signal is applied to gate electrodes, the first transistor T1, the second transistor T2, the third transistor T3, and the fourth transistor can be turned on.

As described above, all the plurality of transistors which configure the third stage circuit STC3 is formed by the same or substantially same transistor type so that a stage circuit process can be more simplified.

The third stage circuit STC3 can include a selection scan signal generating unit SSG and a third output unit OUT3.

The third output unit OUT3 can include a first controller CON1 and a second controller CON2. The first controller CON1 supplies the selection scan signal SSCn to any one of a first output node NP1 and a second output node NP2, based on the selection scan signal SSCn and the control signal CS. The second controller CON2 controls a voltage of the first output node NP1 and a voltage of the second output node NP2, based on the first clock signal CLK1, the first voltage VGH, and the second voltage VGL, outputs a voltage of the first output node NP1 as a first scan signal SCAN1(n), and outputs a voltage of the second output node NP2 as a second scan signal SCAN2(n). In the meantime, the control signal CS can include a first control signal CS1 and a second control signal CS2.

The first controller CON1 can include a first transistor T1 and a second transistor T2.

The first transistor T1 can be connected between an input node N1 to which the selection scan signal SSCn is supplied and the first output node NP1 and a gate electrode of the first transistor T1 can be connected to a first control signal line to which a first control signal CS1 is supplied. The first transistor T1 can be turned on or turned off by the first control signal CS1. For example, when a low level of first control signal CS1 which is a turn-on level is supplied, the first transistor T1 can electrically connect the input node N1 and the first output node NP1. In this case, a voltage of the input node N1, for example, the selection scan signal SSCn can be supplied to the first output node NP1.

The second transistor T2 can be connected between the input node N1 to which the selection scan signal SSCn is supplied and the second output node NP2 and a gate electrode of the second transistor T2 can be connected to a second control signal line to which the second control signal CS2 is supplied. The second transistor T2 can be turned on or turned off by the second control signal CS2. For example, when a low level of second control signal CS2 which is a turn-on level is supplied, the second transistor T2 can electrically connect the input node N1 and the second output node NP2. In this case, a voltage of the input node N1, for example, the selection scan signal SSCn can be supplied to the second output node NP2.

According to a signal level of the first control signal CS1 supplied to the first control signal line and a signal level of the second control signal CS2 supplied to the second control signal line, any one of the first transistor T1 and the second transistor T2 can be turned on and the other transistor can be turned off.

For example, in a corresponding scanning period SP of a pixel row to which the first scan signal SCAN1(n) and the second scan signal SCAN2(n) output by the third stage circuit STC3 are supplied, for example, an n-th pixel row, a signal level of the first control signal CS1 and a signal level of the second control signal CS2 can be opposite. Therefore, when a low level of first control signal CS1 is supplied and a high level of second control signal CS2 is supplied, only the first transistor T1 is turned on so that the selection scan signal SSCn is supplied to the first output node NP1 and the selection scan signal SSCn is not supplied to the second output node NP2. Further, when a high level of first control signal CS1 is supplied and a low level of second control signal CS2 is supplied, only the second transistor T2 is turned on so that the selection scan signal SSCn is supplied to the second output node NP2 and the selection scan signal SSCn is not supplied to the first output node NP1.

As described above, the first controller CON1 can supply the selection scan signal SSCn to any one of the first output node NP1 and the second output node NP2.

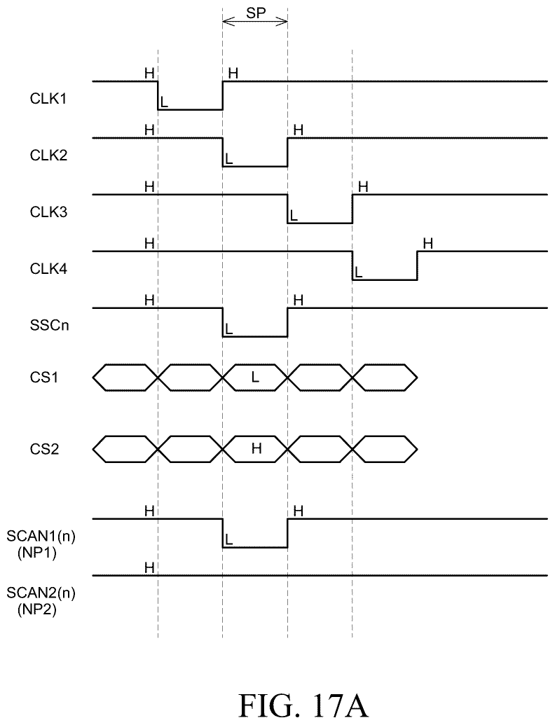

FIGS. 17A and 17B are waveform charts for explaining an example of an operation of the stage circuit of FIG. 16.

In the meantime, FIG. 17A illustrates a waveform chart for explaining an example that a pixel unit PXU to which a first scan signal SCAN1(n) and a second scan signal SCAN2(n) output by the third stage circuit STC3 described with reference to FIG. 16 are supplied is driven in a first mode. FIG. 17B illustrates a waveform chart for explaining an example that a pixel unit PXU to which a first scan signal SCAN1(n) and a second scan signal SCAN2(n) output by the third stage circuit STC3 described with reference to FIG. 16 are supplied is driven in a second mode.

First, a mode in which the corresponding pixel unit PXU is driven in a first mode which is a wide field-of-view mode will be described with reference to FIGS. 16 and 17A. The third transistor T3 and the fourth transistor T4 are turned on by the first clock signal CLK1 which has a low level L in a period prior to the scanning period SP. Therefore, prior to the scanning period, for example, in a previous period, a voltage of the first output node NP1 and a voltage of the second output node NP2 can have a high level H.

In the scanning period SP, the first control signal CS1 has a low level L and the second control signal CS2 has a high level H so that the first transistor T1 can be turned on and the second transistor T2 can be turned off.

Accordingly, as described above, the selection scan signal SSCn having a low level L is supplied to the first output node NP1 by the turned-on first transistor T1 so that in the corresponding scanning period SP, a voltage of the first output node NP1 can have a low level L. Therefore, in the corresponding scanning period SP, the first scan signal SCAN1(n) can be output as a low level L which is a voltage of the first output node NP1.

In the meantime, in the corresponding scanning period SP, the second transistor T2 is turned off or maintains a turned-off state so that the voltage of the second output node NP2 can be maintained at a high level H which is a voltage prior to the corresponding scanning period SP. Therefore, in the corresponding scanning period SP, the second scan signal SCAN2(n) can be output as a high level H which is a voltage of the second output node NP2.

Next, a mode in which the corresponding pixel unit PXU is driven in a second mode which is a narrow field-of-view mode will be described with reference to FIGS. 16 and 17B. The third transistor T3 and the fourth transistor T4 are turned on by the first clock signal CLK1 which has a low level L in a period prior to the scanning period SP. Therefore, prior to the scanning period SP, for example, in a previous period, a voltage of the first output node NP1 and a voltage of the second output node NP2 can have a high level H.

In the scanning period SP, the first control signal CS1 has a high level H and the second control signal CS2 has a low level L so that the second transistor T2 can be turned on and the first transistor T1 can be turned off.

Accordingly, the selection scan signal SSCn having a low level Lis supplied to the second output node NP2 by the turned-on second transistor T2 so that in the corresponding scanning period SP, a voltage of the second output node NP2 can have a low level L. Therefore, in the corresponding scanning period SP, the second scan signal SCAN2(n) can be output as a low level L which is a voltage of the second output node NP2.

In the corresponding scanning period SP, the first transistor T1 is turned off or maintains a turned-off state so that the voltage of the first output node NP1 can be maintained at a high level H which is a voltage prior to the corresponding scanning period SP. Therefore, in the corresponding scanning period SP, the first scan signal SCAN1(n) can be output as a high level H which is a voltage of the first output node NP1.

As described above, according to a signal level of the first control signal CS1 and the second control signal CS2 in the scanning period SP of a corresponding pixel row, the first transistor T1 is turned on to output a low level L of first scan signal SCAN1(n) or the second transistor T2 is turned on to output a low level L of second scan signal SCAN2(n).

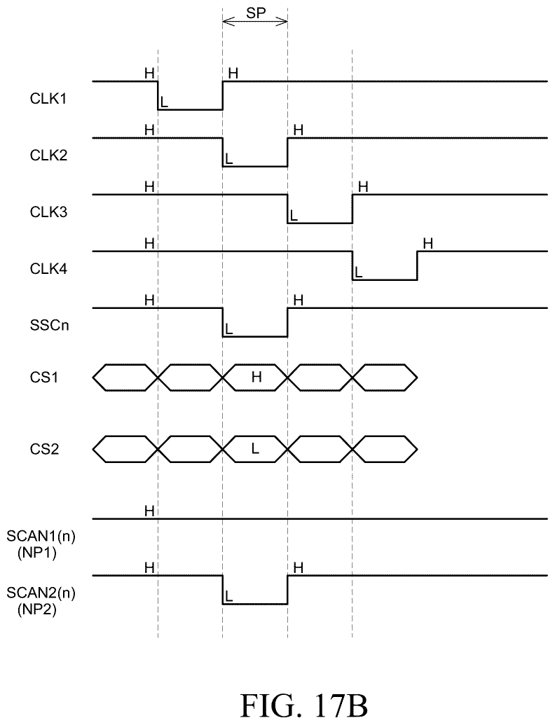

FIG. 18 is a circuit diagram illustrating still another example of a stage circuit included in the gate driving circuit of FIG. 11.

In the meantime, a fourth stage circuit STC4 illustrated in FIG. 18 represents still another example of a stage circuit corresponding to a stage connected to a first clock line and a second clock line, among a plurality of stages ST1, ST2, ST3, ST4, . . . , STn, . . . , STp included in a gate driving circuit GD which has been described with reference to FIG. 11, for example, an n-th stage STn. For example, FIG. 18 illustrates a modified example of an example embodiment of FIG. 12, with regard to a transistor type of a second transistor T2 and a first inverter IVT1 so that a redundant description will not be repeated.

Referring to FIG. 18, all a plurality of transistors included in the fourth stage circuit STC4 can be p-type transistors. For example, the first transistor T1, the second transistor T2, the third transistor T3, and the fourth transistor included in the fourth stage circuit STC4 can be p-type transistors. Accordingly, when a low level of signal is applied to gate electrodes, the first transistor T1, the second transistor T2, the third transistor T3, and the fourth transistor can be turned on.

As described above, all the plurality of transistors which configure the fourth stage circuit STC4 is formed by the same or substantially same transistor type so that a stage circuit process can be more simplified.

The fourth stage circuit STC4 can include a selection scan signal generating unit SSG and a fourth output unit OUT4.

The fourth output unit OUT4 can include a first controller CON1, a second controller CON2, and a first inverter IVT1. The first controller CON1 supplies the selection scan signal SSCn to any one of a first output node NP1 and a second output node NP2, based on the selection scan signal SSCn and the control signal CS. The second controller CON2 controls a voltage of the first output node NP1 and a voltage of the second output node NP2, based on the first clock signal CLK1, the first voltage VGH, and the second voltage VGL, outputs a voltage of the first output node NP1 as a first scan signal SCAN1(n), and outputs a voltage of the second output node NP2 as a second scan signal SCAN2(n).

The first inverter IVT1 can be connected between a control signal line to which the control signal CS is supplied and a gate electrode of the second transistor T2. For example, the first inverter IVT1 can include an input terminal connected to the control signal line and an output terminal connected to the gate electrode of the second transistor T2. Accordingly, a control signal CS' with an inverted signal level can be supplied to the gate electrode of the second transistor T2.

The first controller CON1 can include a first transistor T1 and a second transistor T2.

The first transistor T1 can be connected between an input node N1 to which the selection scan signal SSCn is supplied and the first output node NP1 and a gate electrode of the first transistor T1 can be connected to a control signal line to which the control signal CS is supplied. The first transistor T1 can be turned on or turned off by the control signal CS. For example, when a low level of control signal CS which is a turn-on level is supplied, the first transistor T1 can electrically connect the input node N1 and the first output node NP1. In this case, a voltage of the input node N1, for example, the selection scan signal SSCn can be supplied to the first output node NP1.

The second transistor T2 can be connected between the input node N1 to which the selection scan signal SSCn is supplied and the second output node NP2 and the gate electrode of the second transistor T2 can be connected to an output terminal of the first inverter IVT1 to which a control signal CS' with an inverted signal level is supplied. The second transistor T2 can be turned on or turned off by the inverted control signal CS′. For example, when a low level of inverted control signal CS' which is a turn-on level is supplied, the second transistor T2 can electrically connect the input node N1 and the second output node NP2. In this case, a voltage of the input node N1, for example, the selection scan signal SSCn can be supplied to the second output node NP2.

Here, the control signal CS and the control signal CS' which is output from the first inverter IVT1 to have an inverted signal level have opposite signal levels so that any one of the first transistor T1 and the second transistor T2 can be turned on and the other transistor can be turned off.

Accordingly, the first controller CON1 can supply the selection scan signal SSCn to any one of the first output node NP1 and the second output node NP2.

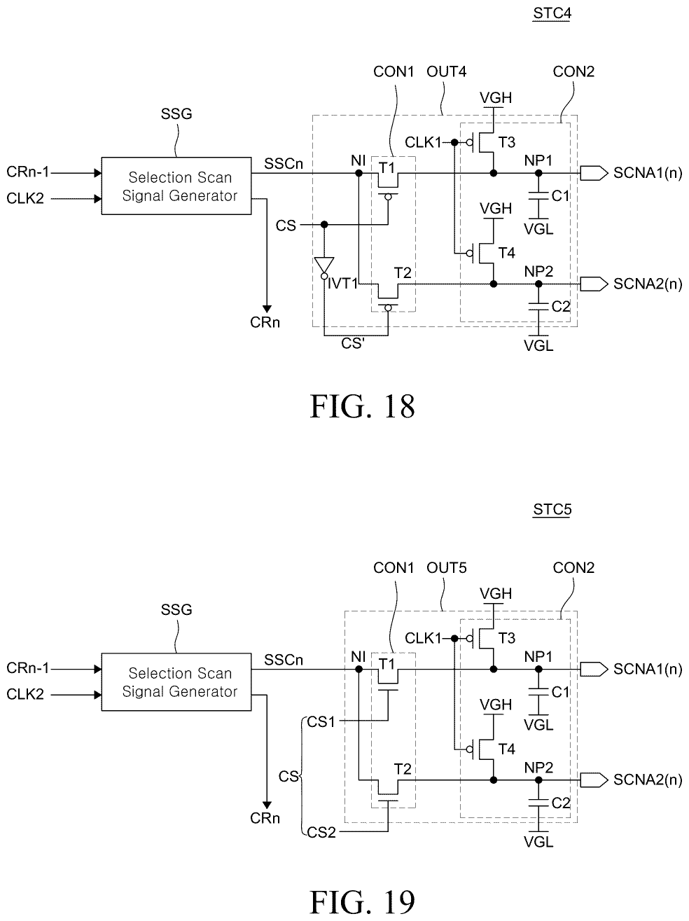

FIG. 19 is a circuit diagram illustrating still another example of a stage circuit included in the gate driving circuit of FIG. 11.

In the meantime, a fifth stage circuit STC5 illustrated in FIG. 19 represents still another example of a stage circuit corresponding to a stage connected to a first clock line and a second clock line, among a plurality of stages ST1, ST2, ST3, ST4, . . . , STn, . . . , STp included in a gate driving circuit GD which has been described with reference to FIG. 11, for example, an n-th stage STn. For example, FIG. 19 illustrates a modified example of an example embodiment of FIG. 16, with regard to a transistor type of a first transistor T1 and a second transistor T2 so that a redundant description will not be repeated.

Referring to FIG. 19, a fifth stage circuit STC5 can include a selection scan signal generating unit SSG and a fifth output unit OUT5.

At least some of a plurality of transistors included in a fifth output unit OUT5 of a fifth stage circuit STC5 can be an n-type transistor or a p-type transistor. For example, the third transistor T3 and the fourth transistor included in the fifth output unit OUT5 in the fifth stage circuit STC5 can be p-type transistors and the first transistor T1 and the second transistor T2 can be n-type transistors.

Accordingly, when a low level of signal is applied to gate electrodes, the third transistor T3 and the fourth transistor can be turned on and when a high level of signal is applied to gate electrodes, the first transistor T1 and the second transistor T2 can be turned on.

For example, when a high level of first control signal CS1 is supplied and a low level of second control signal CS2 is supplied, only the first transistor T1 is turned on to supply a low level of selection scan signal SSCn to the first output node NP1. When a low level of first control signal CS1 is supplied and a high level of second control signal CS2 is supplied, only the second transistor T2 is turned on to supply a low level of selection scan signal SSCn to the second output node NP2.

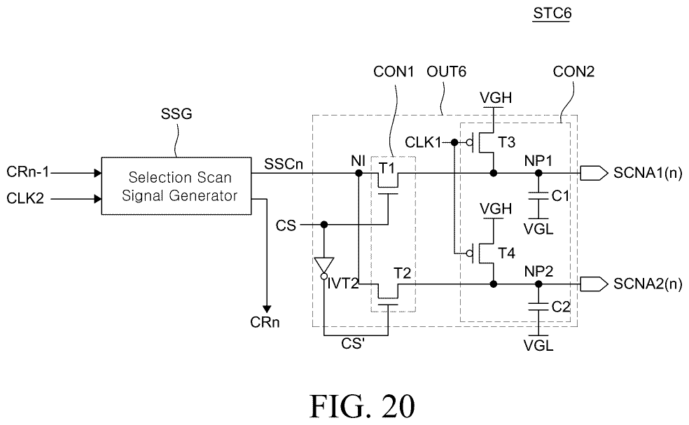

FIG. 20 is a circuit diagram illustrating still another example of a stage circuit included in the gate driving circuit of FIG. 11.

In the meantime, a sixth stage circuit STC6 illustrated in FIG. 20 represents still another example of a stage circuit corresponding to a stage connected to a first clock line and a second clock line, among a plurality of stages ST1, ST2, ST3, ST4, . . . , STn, . . . , STp included in a gate driving circuit GD which has been described with reference to FIG. 11, for example, an n-th stage STn. For example, FIG. 20 illustrates a modified example of an example embodiment of FIG. 18, with regard to a transistor type of a first transistor T1 and a second transistor T2 so that a redundant description will not be repeated.

Referring to FIG. 20, a sixth stage circuit STC6 can include a selection scan signal generating unit SSG and a sixth output unit OUT6.

The sixth output unit OUT6 can include a first controller CON1, a second controller CON2, and a second inverter IVT2. The first controller CON1 supplies the selection scan signal SSCn to any one of a first output node NP1 and a second output node NP2, based on the selection scan signal SSCn and the control signal CS. The second controller CON2 controls a voltage of the first output node NP1 and a voltage of the second output node NP2, based on the first clock signal CLK1, the first voltage VGH, and the second voltage VGL, outputs a voltage of the first output node NP1 as a first scan signal SCAN1(n), and outputs a voltage of the second output node NP2 as a second scan signal SCAN2(n).

The second inverter IVT2 can be connected between a control signal line to which the control signal CS is supplied and a gate electrode of the second transistor T2. For example, the second inverter IVT2 can include an input terminal connected to the control signal line and an output terminal connected to the gate electrode of the second transistor T2. Accordingly, a control signal CS' whose signal level is inverted can be supplied to the gate electrode of the second transistor T2.

At least some of a plurality of transistors included in a sixth output unit OUT6 of a sixth stage circuit STC6 can be an n-type transistor or a p-type transistor. For example, the third transistor T3 and the fourth transistor included in the sixth output unit OUT6 in the sixth stage circuit STC6 can be p-type transistors and the first transistor T1 and the second transistor T2 can be n-type transistors.

Accordingly, when a low level of signal is applied to gate electrodes, the third transistor T3 and the fourth transistor can be turned on and when a high level of signal is applied to gate electrodes, the first transistor T1 and the second transistor T2 can be turned on.

For example, when the high level of control signal CS is supplied, only the first transistor T1 is turned on to supply a low level of selection scan signal SSCn to the first output node NP1. When the low level of control signal CS is supplied, only the second transistor T2 is turned on to supply a low level of selection scan signal SSCn to the second output node NP2.

A gate driving circuit according to the example embodiments of the present disclosure will be described as follows.

A gate driving circuit according to an example embodiment of the present disclosure can include first to p-th (p is an integer larger than 1) stages, an n-th (n is an integer which is equal to or larger than 1 and equal to or smaller than p) stage among the first to p-th stages can include: a selection scan signal generating unit configured to output a selection scan signal, based on an input signal which is any one of a start signal or a previous carry signal and a second clock signal; and an output unit configured to output a first scan signal and a second scan signal based on the selection scan signal, a first scan signal, and a control signal. The output unit can include a first controller configured to supply the selection scan signal to any one of a first output node and a second output node, based on the selection scan signal and the control signal; and a second controller configured to control a voltage of the first output node and a voltage of the second output node, outputs a voltage of the first output node as the first scan signal, and outputs a voltage of the second output node as the second scan signal, based on the first clock signal, a first voltage, and a second voltage which is lower than the first voltage.

According to another feature of the present disclosure, in a period in which any one of the first scan signal and the second scan signal has a turn-on level, the other one can have a turn-off level.

According to still another feature of the present disclosure, the first controller can include a first transistor which is connected between an input node to which the selection scan signal is supplied and the first output node and includes a gate electrode connected to a control signal line to which the control signal is supplied; and a second transistor which is connected between the input node and the second output node and includes a gate electrode connected to the control signal line.

According to still another feature of the present disclosure, according to a signal level of the control signal, in a period in which any one of the first transistor and the second transistor is turned on, the other one can be turned off.

According to still another feature of the present disclosure, the control signal can include a first control signal and a second control signal, and the first controller can include a first transistor which is connected between an input node to which the selection scan signal is supplied and the first output node and includes a gate electrode connected to a first control signal line to which the first control signal is supplied; and a second transistor which is connected between the input node and the second output node and includes a gate electrode connected to a second control signal line to which the second control signal is supplied.

According to still another feature of the present disclosure, in a period in which any one of the first control signal and the second control signal has a turn-on level, the other one can have a turn-off level.

According to still another feature of the present disclosure, the output unit can further include an inverter configured to invert a signal level of the control signal which is supplied to an input terminal to output an inverted control signal to an output terminal.

According to still another feature of the present disclosure, the first controller can include a first transistor which is connected between an input node to which the selection scan signal is supplied and the first output node and includes a gate electrode connected to a control signal line to which the control signal is supplied; and a second transistor which is connected between the input node and the second output node and includes a gate electrode connected to an output terminal of the inverter.

According to still another feature of the present disclosure, according to signal levels of the control signal and the inverted control signal, in a period in which any one of the first transistor and the second transistor is turned on, the other one can be turned off.

According to still another feature of the present disclosure, the second controller can include a third transistor which is connected between a first voltage line to which the first voltage is supplied and the first output node and includes a gate electrode connected to a first clock line to which the first clock signal is supplied; a fourth transistor which is connected between the first voltage line and the second output node and includes a gate electrode connected to the first clock line; a first capacitor which is connected between the first output node and a second voltage line to which the second voltage is supplied; and a second capacitor which is connected between the second output node and the second voltage line.

According to still another feature of the present disclosure, the first clock signal and the second clock signal are set to have the same cycle and the second clock signal can be delayed by a quarter cycle from the first clock signal.

The display device according to the example embodiments of the present disclosure will be described as follows.

The display device according to the example embodiments of the present disclosure can include a first pixel which is connected to a first scan line, a data line, a first power line to which a first power voltage is supplied, and a second power line to which a second power voltage is supplied; a second pixel which is connected to a second scan line, the data line, the first power line, and the second power line; a gate driving circuit configured to supply a first scan signal and a second scan signal to the first scan line and the second scan line, respectively; and a data driver configured to supply a data signal to the data line. When any one of the first scan signal and the second scan signal has a turn-on level, the other one can have a turn-off level.

According to another feature of the present disclosure, in a first mode including a period in which the first scan signal has a turn-on level, the data signal is supplied to the first pixel so that the first pixel can emit light and in a second mode including a period in which the second scan signal has a turn-on level, the data signal is supplied to the second pixel so that the second pixel can emit light.

According to still another feature of the present disclosure, the first pixel can include a first light emitting diode; a first driving transistor which is connected between the first power line and a third node and generates a first driving current flowing from the first power line to the second power line via the first light emitting diode; a first scan transistor which is connected between the data line and the first node and is turned on in response to the first scan signal; and a first storage capacitor which is connected between the first node and a second node corresponding to a gate electrode of the first driving transistor. The second pixel can include a second light emitting diode configured to emit the same or substantially same color light as the first light emitting diode; a second driving transistor which is connected between the first power line and the sixth node and generates a second driving current flowing from the first power line to the second power line via the second light emitting diode; a second scan transistor which is connected between the data line and a fourth node and is turned on in response to the second scan signal; and a second storage capacitor which is connected between the fourth node and a fifth node corresponding to a gate electrode of the second driving transistor.

According to still another feature of the present disclosure, the first pixel can further include a first selection transistor which is connected between the third node and the first light emitting diode and is turned on in response to a first selection signal which is supplied to a first selection signal line, and the second pixel can further include a second selection transistor which is connected between the sixth node and the second light emitting diode and is turned on in response to a second selection signal which is supplied to a second selection signal line.

According to still another feature of the present disclosure, in a first mode including a period in which the first scan signal has a turn-on level, the first selection signal can include a turn-on level of pulse and the second selection signal can be maintained at a turn-off level and in a second mode including a period in which the second scan signal has a turn-on level, the second selection signal can include a turn-on level of pulse and the first selection signal can be maintained at a turn-off level.

According to still another feature of the present disclosure, the first selection signal and the second selection signal can be the same signal.

Although the example embodiments of the present disclosure have been described in detail with reference to the accompanying drawings, the present disclosure is not limited thereto and can be embodied in many different forms without departing from the technical concept of the present disclosure. Therefore, the example embodiments of the present disclosure are provided for illustrative purposes only but not intended to limit the technical idea of the present disclosure. The scope of the technical idea of the present disclosure is not limited thereto. Therefore, it can be understood that the above-described example embodiments are illustrative in all aspects and do not limit the present disclosure.

What is claimed is:

1. A gate driving circuit, comprising:
first to p-th stages, wherein p is an integer larger than 1,
wherein an n-th stage among the first to p-th stages includes:
a selection scan signal generating unit configured to output a selection scan signal, based on an input signal which is any one of a start signal or a previous carry signal and a second clock signal; and
an output unit configured to output a first scan signal and a second scan signal based on a first selection scan signal, a first clock signal, and a control signal,
wherein the output unit includes:
a first controller configured to supply the selection scan signal to any one of a first output node and a second output node, based on the selection scan signal and the control signal; and
a second controller configured to control a voltage of the first output node and a voltage of the second output node, output the voltage of the first output node as the first scan signal, and output the voltage of the second output node as the second scan signal, based on the first clock signal, a first voltage, and a second voltage being lower than the first voltage, and
wherein n is an integer which is equal to or larger than 1 and equal to or smaller than p.

2. The gate driving circuit according to claim 1, wherein in a period in which any one of the first scan signal and the second scan signal has a turn-on level, the other one of the first scan signal and the second scan signal has a turn-off level.

3. The gate driving circuit according to claim 1, wherein the first controller includes:
a first transistor connected between an input node to which the selection scan signal is supplied and the first output node, and including a gate electrode connected to a control signal line to which the control signal is supplied; and
a second transistor connected between the input node and the second output node and including a gate electrode connected to the control signal line.

4. The gate driving circuit according to claim 3, wherein according to a signal level of the control signal, in a period in which any one of the first transistor and the second transistor is turned on, the other one of the first transistor and the second transistor is turned off.

5. The gate driving circuit according to claim 1, wherein the control signal includes a first control signal and a second control signal, and
wherein the first controller includes:
a first transistor connected between an input node to which the selection scan signal is supplied and the first output node, and including a gate electrode connected to a first control signal line to which the first control signal is supplied; and
a second transistor connected between the input node and the second output node and including a gate electrode connected to a second control signal line to which the second control signal is supplied.

6. The gate driving circuit according to claim 5, wherein in a period in which any one of the first control signal and the second control signal has a turn-on level, the other one of the first control signal and the second control signal has a turn-off level.

7. The gate driving circuit according to claim 1, wherein the output unit further includes an inverter configured to invert a signal level of the control signal which is supplied to an input terminal to output an inverted control signal to an output terminal.

8. The gate driving circuit according to claim 7, wherein the first controller includes:
a first transistor connected between an input node to which the selection scan signal is supplied and the first output node, and including a gate electrode connected to a control signal line to which the control signal is supplied; and
a second transistor connected between the input node and the second output node and including a gate electrode connected to an output terminal of the inverter.

9. The gate driving circuit according to claim 8, wherein according to signal levels of the control signal and the inverted control signal, in a period in which any one of the first transistor and the second transistor is turned on, the other one of the first transistor and the second transistor is turned off.

10. The gate driving circuit according to claim 1, wherein the second controller includes:
a third transistor connected between a first voltage line to which the first voltage is supplied and the first output node, and including a gate electrode connected to a first clock line to which the first clock signal is supplied;
a fourth transistor connected between the first voltage line and the second output node and including a gate electrode connected to the first clock line;
a first capacitor connected between the first output node and a second voltage line to which the second voltage is supplied; and
a second capacitor connected between the second output node and the second voltage line.

11. The gate driving circuit according to claim 1, wherein the first clock signal and the second clock signal are set to have a same cycle, and the second clock signal is delayed by a phase difference of a quarter cycle from the first clock signal.

12. A display device, comprising:
a first pixel connected to a first scan line, a data line, a first power line to which a first power voltage is supplied, and a second power line to which a second power voltage is supplied;
a second pixel connected to a second scan line, the data line, the first power line, and the second power line;
a gate driving circuit configured to supply a first scan signal and a second scan signal to the first scan line and the second scan line, respectively; and
a data driver configured to supply a data signal to the data line,
wherein in a period in which any one of the first scan signal and the second scan signal has a turn-on level, the other one of the first scan signal and the second scan signal has a turn-off level.

13. The display device according to claim 12, wherein in a first mode including a period in which the first scan signal has the turn-on level, the data signal is supplied to the first pixel so that the first pixel emits light, and
wherein in a second mode including a period in which the second scan signal has the turn-on level, the data signal is supplied to the second pixel so that the second pixel emits light.

14. The display device according to claim 12, wherein the first pixel includes:
a first light emitting diode;
a first driving transistor connected between the first power line and a third node and configured to generate a first driving current flowing from the first power line to the second power line via the first light emitting diode;
a first scan transistor connected between the data line and a first node and configured to be turned on in response to the first scan signal; and
a first storage capacitor connected between the first node and a second node corresponding to a gate electrode of the first driving transistor, and
wherein the second pixel includes:
a second light emitting diode configured to emit a same color light as the first light emitting diode;
a second driving transistor connected between the first power line and a sixth node and configured to generate a second driving current flowing from the first power line to the second power line via the second light emitting diode;
a second scan transistor connected between the data line and a fourth node and configured to be turned on in response to the second scan signal; and
a second storage capacitor connected between the fourth node and a fifth node corresponding to a gate electrode of the second driving transistor.

15. The display device according to claim 14, wherein the first pixel further includes a first selection transistor connected between the third node and the first light emitting diode and configured to be turned on in response to a first selection signal which is supplied to a first selection signal line, and
wherein the second pixel further includes a second selection transistor connected between the sixth node and the second light emitting diode and configured to be turned on in response to a second selection signal which is supplied to a second selection signal line.

16. The display device according to claim 15, wherein in a first mode including a period in which the first scan signal has the turn-on level, the first selection signal includes a turn-on level of pulse and the second selection signal is maintained at the turn-off level, and
wherein in a second mode including a period in which the second scan signal has the turn-on level, the second selection signal includes the turn-on level of pulse and the first selection signal is maintained at the turn-off level.

17. The display device according to claim 15, wherein the first selection signal and the second selection signal are same signals.
